(19) United States
(12) Patent Application Publication
(10) Pub. No.: US 2026/0307043 A1
(43) Pub. Date: Oct. 8, 2026

(54) SORBENT SUPPORT MATERIALS AND SYSTEMS COMPRISING THE SAME

(71) Applicant: Georgia Tech Research Corporation, Atlanta, GA (US)

(72) Inventors: Pasquale Fernando Fulvio, Atlanta, GA (US); Krista Walton, Atlanta, GA (US); JiaJi Lin, Atlanta, GA (US)

(21) Appl. No.: 19/638,805

(22) Filed: Apr. 3, 2026

Related U.S. Application Data
(60) Provisional application No. 63/783,793, filed on Apr. 4, 2025.

(51) Int. Cl. B01J 20/10; B01J 20/04

(52) U.S. Cl. CPC B01J 20/103; B01J 20/046

(57) ABSTRACT

The present disclosure relates generally to hierarchical porous materials and composite sorbents, and more particularly to hierarchical mesoporous-macroporous silica support materials with independently tunable pore structures and composite sorbents including hygroscopic salts supported thereon for atmospheric water generation, thermal energy storage, gas separation, and related applications. A hierarchical porous silica material includes a silica framework defining a plurality of mesopores having a pore width in a range of 2 nm to 11 nm and a plurality of macropores having a pore diameter in a range of 0.1 μm to 100 μm, wherein the mesopores exhibit a narrow pore size distribution with a full width at half maximum of less than 2 nm, and wherein the macropores are formed by aggregation of primary silica particles.

### CROSS-REFERENCE TO RELATED APPLICATIONS

This application claims the benefit of U.S. Provisional Application Ser. No. 63/783,793, filed on 4 Apr. 2025, which is incorporated herein by reference in its entirety as if fully set forth below.

### GOVERNMENT LICENSE RIGHTS

This invention was made with government support under HR0011-21-2-0001 awarded by the Defense Advanced Research Projects Agency. The government has certain rights in this invention.

### FIELD OF INVENTION

The present disclosure relates to hierarchical porous materials and composite sorbents, and more particularly to hierarchical mesoporous-macroporous silica support materials with independently tunable pore structures and composite sorbents comprising hygroscopic salts supported thereon for atmospheric water generation, thermal energy storage, gas separation, and related applications.

### BACKGROUND

Atmospheric water generation (AWG) represents a promising technology for extracting water from air on demand across various size scales. Potential applications include defense, first responder operations, civilian use, agriculture, and industrial processes. Existing and developing AWG devices are based on sorbent technologies or on condenser/heat exchanger technologies. Sorbent-based devices generally outperform condenser/heat exchanger type devices at extreme temperature and humidity conditions.

Thermal energy storage (TES) systems also benefit from sorbent materials, as these systems utilize the energy of adsorption-desorption processes between vapors and salts or composite sorbents. In passive TES devices, cool and humid ambient air flows through a sorbent bed, where composite sorbents saturate and release heat. The sorbents are regenerated by inputting heat into the system through electric heaters attached to a grid or battery, or through solar heaters. This process absorbs heat and cools the flowing air. Similar principles apply to systems using ammonia as a vapor, where the heat of adsorption-desorption is utilized for heating and cooling applications. Supported sorbents reduce corrosion of unsupported salts in TES systems, such as chemical heat pumps.

Known sorbents for these applications include porous supports such as metal-organic frameworks (MOFs), zeolitic imidazolate frameworks (ZIFs), zeolites, silicas, inorganic oxides, and composites that support inorganic hygroscopic salts. These hygroscopic salts include lithium, sodium, potassium, magnesium, calcium, and other metal halides, carbonates, sulfates, nitrates, and acetates. Supports not containing hygroscopic salts often exhibit type I, type III, or type V adsorption isotherms depending on the pore size of the support. The preferred supports have mesopores in the range of 2 nm to 50 nm in size, specific surface areas greater than 200 m²/g, and mesopore volumes of at least 0.4 cm³/g. The preferred supports also have strong affinity for hygroscopic salts to keep these dispersed onto their surfaces and prevent extensive salt aggregation.

Hierarchical porous silica materials incorporating both mesopores and macropores have been developed using dual-templating approaches. In these syntheses, one structure-directing agent forms a mesophase with the silica sol, while a second template undergoes spinodal decomposition to create macropores. Surfactants such as alkyltrimethylammonium bromides and triblock copolymers have been used to template mesopores, while high molecular weight polymers such as polyethylene glycol (PEG) and polyvinyl alcohol (PVA) have been used to template macropores through phase separation mechanisms.

However, existing synthesis methods for hierarchical porous silica materials suffer from several limitations. Prior methods for producing hierarchical silica monoliths require multiple synthesis steps, including separate stages for silica condensation, hydrothermal treatment, neutralization, acidification, washing, drying, and calcination, resulting in lengthy synthesis times exceeding 170 hours. These multi-step processes are difficult to scale and often produce monolithic materials that require ball milling to obtain powders, leading to particle-size variability and partial loss of macropore structure. Additionally, prior methods have demonstrated control over either mesopore volume or macropore size, but not simultaneous and independent control over both mesopore size and macropore size within narrow distributions. Commercial oxide supports typically have broad pore size distributions and lack controlled macropores, limiting their effectiveness as sorbent supports.

What is needed, therefore, is a simplified synthesis method for producing hierarchical porous silica materials in powder form that enables simultaneous and independent control over both mesopore size and macropore size with narrow pore size distributions. Such materials would provide tunable porosity for optimized vapor transport and salt loading, scalable production for commercial applications, and enhanced performance as sorbent supports for atmospheric water generation, thermal energy storage, gas separation, and related applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a hierarchical porous silica material can be provided. The hierarchical porous silica material can include a silica framework defining a plurality of mesopores having a pore width in a range of 2 nm to 11 nm. The hierarchical porous silica material can include a plurality of macropores having a pore diameter in a range of 0.1 μm to 100 μm. The mesopores can exhibit a narrow pore size distribution with a full width at half maximum of less than 2 nm. The macropores can be formed by aggregation of primary silica particles.

According to another aspect of the present disclosure, a method for preparing a hierarchical porous silica material can be provided. The method can include dissolving a surfactant and a polymer in a solvent to form a solution, wherein the surfactant includes an alkyltrimethylammonium bromide and the polymer includes polyethylene glycol having a molecular weight of at least 10,000 g/mol. The method can include adding a silica precursor to the solution. The method can include adding a condensation catalyst to the solution to form a silica gel. The method can include subjecting the silica gel to hydrothermal treatment. The method can include calcining the silica gel to remove the surfactant and the polymer, thereby producing a hierarchical porous silica material having mesopores templated by the surfactant and macropores templated by the polymer.

According to another aspect of the present disclosure, a composite sorbent can be provided. The composite sorbent can include a hierarchical porous silica support including mesopores having a pore width in a range of 2 nm to 11 nm and macropores having a pore diameter greater than 50 nm. The composite sorbent can include a hygroscopic salt disposed within the mesopores of the hierarchical porous silica support, wherein the hygroscopic salt is present in an amount of 5 wt % to 60 wt % based on a total weight of the composite sorbent.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a flow diagram for a method for preparing hierarchical porous silica monoliths using a prior art synthesis process.

FIG. 2 is a flow diagram for a method for preparing hierarchical porous silica powders using a simplified synthesis process, according to examples of the disclosed technology.

FIG. 3A illustrates nitrogen adsorption-desorption isotherms and pore size distribution curves for hierarchical silica materials, according to examples of the disclosed technology.

FIG. 3C illustrates nitrogen adsorption-desorption isotherms and pore size distribution curves for hierarchical silica materials prepared using different solvent systems, according to examples of the disclosed technology.

FIG. 3E illustrates nitrogen adsorption-desorption isotherms for hierarchical silica samples prepared under different catalysis conditions, according to examples of the disclosed technology.

FIG. 4A illustrates mercury intrusion porosimetry data and pore size distribution curves for hierarchical silica samples, according to examples of the disclosed technology.

FIG. 4B illustrates particle size distribution analysis for hierarchical silica samples prepared using different polyethylene glycol molecular weights, according to examples of the disclosed technology.

FIG. 5A illustrates a scanning electron microscope image of a hierarchical porous silica sample prepared using polyethylene glycol with a molecular weight of 10,000 g/mol, according to examples of the disclosed technology.

FIG. 5B illustrates a scanning electron microscope image of a hierarchical porous silica sample prepared using polyethylene glycol with a molecular weight of 35,000 g/mol, according to examples of the disclosed technology.

FIG. 6 illustrates a bar chart comparing adsorption properties of hierarchical silica and commercial silica support materials, according to examples of the disclosed technology.

FIG. 7 illustrates a schematic showing the relationship between surfactant chain length and resulting silica mesopore width, according to examples of the disclosed technology.

FIG. 8A illustrates nitrogen adsorption-desorption isotherms and pore size distribution curves for hierarchical silica materials prepared using different surfactant chain lengths, according to examples of the disclosed technology.

FIG. 8C illustrates nitrogen adsorption-desorption isotherms for hierarchical silica materials synthesized with polyethylene glycol having a molecular weight of 10,000 g/mol, according to examples of the disclosed technology.

FIG. 8D illustrates nitrogen adsorption-desorption isotherms for hierarchical silica materials synthesized with polyethylene glycol having a molecular weight of 6,000 g/mol, according to examples of the disclosed technology.

FIG. 8E illustrates pore size distribution data for hierarchical porous silica materials prepared in a water-ethanol solvent system, according to examples of the disclosed technology.

FIG. 8F illustrates pore size distribution data for hierarchical porous silica materials prepared in a water solvent system, according to examples of the disclosed technology.

FIG. 9A illustrates nitrogen adsorption-desorption isotherms and pore size distribution curves for hierarchical silica materials prepared using triblock copolymer and polyvinyl alcohol templates, according to examples of the disclosed technology.

FIG. 9C illustrates nitrogen adsorption isotherms for hierarchical silica materials prepared with varying polyvinyl alcohol molecular weights and loading percentages, according to examples of the disclosed technology.

FIG. 9D illustrates nitrogen adsorption isotherms for hierarchical silica materials prepared with different condensation catalysts, according to examples of the disclosed technology.

FIG. 10A illustrates a low magnification transmission electron microscopy image of a hierarchical porous silica material, according to examples of the disclosed technology.

FIG. 10B illustrates a high magnification transmission electron microscopy image revealing ordered mesopore structure of a hierarchical silica material, according to examples of the disclosed technology.

FIG. 10C illustrates a transmission electron microscopy image showing the morphology of a hierarchical porous silica structure, according to examples of the disclosed technology.

FIG. 10D illustrates a transmission electron microscopy image showing ordered mesopore arrangement within silica walls, according to examples of the disclosed technology.

FIG. 10E illustrates a transmission electron microscopy image of a hierarchical porous silica particle aggregate, according to examples of the disclosed technology.

FIG. 10F illustrates a transmission electron microscopy image showing internal porosity of hierarchical silica particle aggregates, according to examples of the disclosed technology.

FIG. 11A illustrates nitrogen adsorption isotherms for hierarchical silica materials loaded with various hygroscopic salts, according to examples of the disclosed technology.

FIG. 11B illustrates nitrogen adsorption isotherms for hierarchical silica materials loaded with varying weight percentages of lithium chloride, according to examples of the disclosed technology.

FIG. 11C illustrates nitrogen adsorption isotherms for hierarchical porous silica materials prepared using different synthesis batches, according to examples of the disclosed technology.

FIG. 11D illustrates pore size distribution curves for hierarchical porous silica materials prepared using different synthesis batches, according to examples of the disclosed technology.

FIG. 12A illustrates desorption profiles of water from a composite sorbent under various temperature and vacuum conditions, according to examples of the disclosed technology.

FIG. 12B illustrates pressure and temperature profiles during desorption experiments for a composite sorbent, according to examples of the disclosed technology.

FIG. 12C illustrates a water vapor adsorption isotherm for a composite sorbent material, according to examples of the disclosed technology.

FIG. 12D illustrates adsorption cycling performance for a composite sorbent material, according to examples of the disclosed technology.

FIG. 12E illustrates adsorption and desorption cycling data for a composite sorbent material over three cycles, according to examples of the disclosed technology.

FIG. 12F illustrates adsorption and desorption cycling data for a composite sorbent material over additional cycles, according to examples of the disclosed technology.

FIG. 13A illustrates isosteric heat of adsorption data for a composite sorbent material, according to examples of the disclosed technology.

FIG. 13B illustrates weight change and differential scanning calorimetry data for salt-silica composite sorbents during cycling, according to examples of the disclosed technology.

FIG. 13C illustrates water vapor adsorption isotherms for composite sorbents prepared with different surfactant chain lengths, according to examples of the disclosed technology.

FIG. 13D illustrates water vapor adsorption isotherms for composite sorbents prepared with different polyethylene glycol molecular weights, according to examples of the disclosed technology.

FIG. 13E illustrates water adsorption isotherms for composite sorbents prepared with different salt types at 35 weight percent loading, according to examples of the disclosed technology.

FIG. 13F illustrates water adsorption isotherms for composite sorbents prepared with different salt types at 50 and 60 weight percent loadings, according to examples of the disclosed technology.

FIG. 13G illustrates nitrogen adsorption isotherms for salt-loaded silica composite sorbents, according to examples of the disclosed technology.

FIG. 13H illustrates water adsorption isotherms for salt-loaded hierarchical silica composites including salt blends, according to examples of the disclosed technology.

FIG. 13J illustrates water adsorption isotherms for composite sorbents containing salt blends with weighted average predictions, according to examples of the disclosed technology.

FIG. 13K illustrates water adsorption isotherms comparing different salt blend systems, according to examples of the disclosed technology.

FIG. 14A illustrates nitrogen adsorption isotherms and pore size distribution curves for silica composites loaded with carbonate salts, according to examples of the disclosed technology.

FIG. 14B illustrates pore size distribution curves for hierarchical silica materials loaded with carbonate and chloride salt compositions, according to examples of the disclosed technology.

FIG. 14C illustrates nitrogen adsorption isotherms for hierarchical silica materials loaded with carbonate and chloride salt compositions, according to examples of the disclosed technology.

FIG. 14D illustrates pore size distribution curves for hierarchical silica materials loaded with carbonate and chloride salt compositions, according to examples of the disclosed technology.

FIG. 14E illustrates nitrogen adsorption isotherms for silica composites loaded with potassium carbonate and chloride salt blends, according to examples of the disclosed technology.

FIG. 14F illustrates pore size distribution curves for silica composites loaded with potassium carbonate and chloride salt blends, according to examples of the disclosed technology.

FIG. 15A illustrates water adsorption behavior of a composite sorbent under different atmospheric conditions, according to examples of the disclosed technology.

FIG. 15B illustrates desorption behavior showing weight and pressure as functions of temperature for a composite sorbent, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to hierarchical porous silica materials and composite sorbents comprising such materials. Hierarchical porous silica materials can comprise a silica framework defining mesopores and macropores, where the mesopores and macropores can be independently tuned during synthesis. The mesopores can have pore widths in a range of 2 nm to 11 nm, while the macropores can have pore diameters in a range of 0.1 μm to 100 μm. The hierarchical porous silica materials can exhibit narrow pore size distributions for both the mesopores and the macropores, providing control over the structural properties of the materials.

The hierarchical porous silica materials can be prepared using a dual-templating approach. A surfactant can template the mesopores through mesophase formation, while a high molecular weight polymer can template the macropores through spinodal decomposition. By selecting different surfactants and polymers, the mesopore size and macropore size can be independently controlled. For example, alkyltrimethylammonium bromide surfactants with different alkyl chain lengths can be used to tune the mesopore width, while polyethylene glycol polymers with different molecular weights can be used to tune the macropore diameter.

In some cases, the surfactant can comprise a combination of two or more alkyltrimethylammonium bromide surfactants with different alkyl chain lengths. For example, a combination of C12TAB and C16TAB, or C14TAB and C18TAB, can be used to tailor the mesopore size and adsorption properties of the hierarchical porous silica materials. The use of surfactant combinations can provide intermediate mesopore sizes or modified pore size distributions compared to materials prepared using a single surfactant. The mesopore size and adsorption properties of the materials can be tailored by adjusting the ratio of surfactants in the combination, enabling further control over the structural characteristics of the hierarchical porous silica materials.

Composite sorbents can be prepared by loading hygroscopic salts into the mesopores of the hierarchical porous silica materials. The hygroscopic salts can include alkali metal salts, alkaline earth metal salts, and combinations thereof. The composite sorbents can exhibit high water uptake capacities across a range of relative humidity conditions. The water uptake capacity can scale with the amount of hygroscopic salt loading and can be inversely related to the molecular weight of the salt.

The composite sorbents can be used in atmospheric water generation (AWG) applications to extract water from air. AWG devices can operate at different size scales and can be used in defense, first responder, civilian, agricultural, and industrial applications. Sorbent-based AWG devices can outperform condenser and heat exchanger type devices at extreme temperature and humidity conditions.

The composite sorbents can also be used in thermal energy storage (TES) systems. TES systems can utilize the energy of adsorption-desorption processes between vapors and the composite sorbents. During adsorption, the composite sorbents can release heat as the hygroscopic salts become saturated with water vapor. During desorption, heat can be supplied to regenerate the sorbents, and the process can absorb heat and cool flowing air. The composite sorbents can also be used with ammonia vapor for heating and cooling applications.

The composite sorbents can be used for gas separation applications, including direct air capture of carbon dioxide and separation of carbon dioxide from post-combustion streams. When the composite sorbents are loaded with alkaline, alkaline earth metal, or amphoteric salts, the composite sorbents can exhibit selectivity for water or carbon dioxide depending on the carbon dioxide concentration. At ambient carbon dioxide concentrations, water can be preferentially adsorbed. At elevated carbon dioxide concentrations, the composite sorbents can exhibit higher selectivity toward carbon dioxide. The composite sorbents can be used in two-bed systems where water and carbon dioxide are separated in an inlet stream, or in single-bed systems where water and carbon dioxide are co-adsorbed.

The composite sorbents can also be used for ammonia storage and transport. Ammonia can serve as a feedstock for manufacturing nitrogen-containing chemicals and as a source of hydrogen gas. The hygroscopic salts in the composite sorbents can form ammoniates and ammonia complexes, providing safe storage and transport of ammonia. Supported salts are less corrosive than unsupported salts.

The hierarchical pore structure of the silica materials can provide advantages for sorbent applications. The macropores can facilitate fast vapor diffusion to the mesopores, while the mesopores can provide high surface area and pore volume for supporting the hygroscopic salts. The narrow pore size distributions can provide high salt loading capacity and stability during adsorption-desorption cycling. The composite sorbents can retain their performance in terms of water capacity and kinetics over multiple cycles.

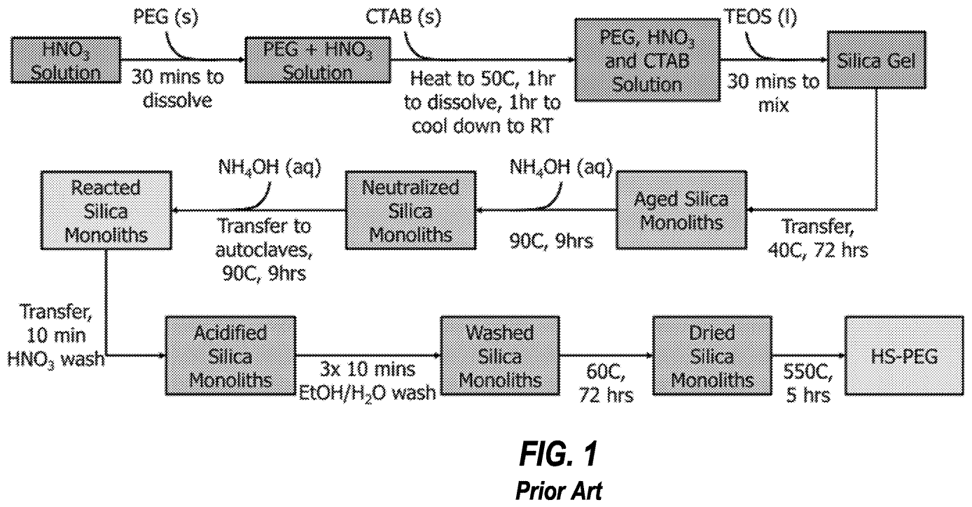

Referring to FIG. 1, a prior art synthesis process for preparing hierarchical porous silica monoliths is depicted. The prior art synthesis process can involve multiple stages and can require lengthy synthesis times. The prior art synthesis process can be used to prepare hierarchical porous silica materials having mesopores and macropores, where the mesopores can be templated by cetyltrimethylammonium bromide (CTAB) and the macropores can be templated by polyethylene glycol (PEG).

The prior art synthesis process can begin with a nitric acid (HNO₃) solution. Polyethylene glycol in solid form can be added to the nitric acid solution and allowed to dissolve for approximately 30 minutes, forming a PEG and HNO₃ solution. Cetyltrimethylammonium bromide in solid form can then be added to the PEG and HNO₃ solution. The resulting mixture can be heated to 50 degrees Celsius for 1 hour to dissolve the cetyltrimethylammonium bromide, followed by cooling to room temperature for 1 hour. The cooling step can produce a PEG, HNO₃, and CTAB solution.

With continued reference to FIG. 1, tetraethyl orthosilicate (TEOS) in liquid form can be added to the PEG, HNO₃, and CTAB solution and mixed for approximately 30 minutes to form a silica gel. The silica gel can then be transferred to autoclaves and subjected to hydrothermal treatment at 40 degrees Celsius for 72 hours in the presence of aqueous ammonium hydroxide (NH₄OH). The hydrothermal treatment can produce aged silica monoliths.

The aged silica monoliths can undergo a neutralization step with aqueous ammonium hydroxide at 90 degrees Celsius for 9 hours, yielding neutralized silica monoliths. The neutralized silica monoliths can then be subjected to an acidification step involving transfer and a 10 minute nitric acid wash, producing acidified silica monoliths.

As further shown in FIG. 1, the acidified silica monoliths can be washed three times for 10 minutes each with an ethanol and water mixture, resulting in washed silica monoliths. The washed silica monoliths can be dried at 60 degrees Celsius for 72 hours to produce dried silica monoliths. The dried silica monoliths can be calcined at 550 degrees Celsius for 5 hours to remove the templates and yield the final hierarchical porous silica monolith product. The calcination step can decompose and remove the polyethylene glycol and cetyltrimethylammonium bromide templates, leaving open mesopores and macropores in the silica framework.

The prior art synthesis process can require total synthesis times exceeding 170 hours when accounting for the dissolution steps, hydrothermal treatment at 40 degrees Celsius for 72 hours, neutralization at 90 degrees Celsius for 9 hours, acidification, washing, drying at 60 degrees Celsius for 72 hours, and calcination at 550 degrees Celsius for 5 hours. The prior art synthesis process can also involve multiple container transfers between the various stages, including transfers for the hydrothermal treatment, neutralization, acidification, and washing steps. The prior art synthesis process can produce monolithic silica materials rather than powder materials.

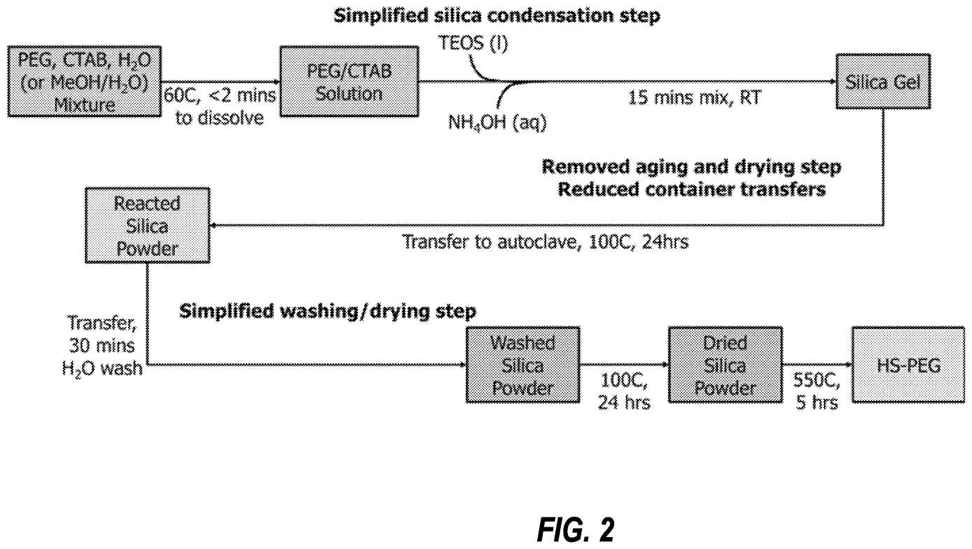

Referring to FIG. 2, a simplified synthesis process for preparing hierarchical porous silica powders is depicted. The simplified synthesis process can be referred to herein as a one-pot synthesis method. The one-pot synthesis method can require fewer steps and shorter synthesis times compared to the prior art synthesis process described above with reference to FIG. 1.

The one-pot synthesis method can begin with a simplified silica condensation step. A surfactant and a polymer can be dissolved together in a solvent to form a solution. The surfactant can comprise an alkyltrimethylammonium bromide. The alkyltrimethylammonium bromide can be selected from the group consisting of decyltrimethylammonium bromide (C10TAB), dodecyltrimethylammonium bromide (C12TAB), tetradecyltrimethylammonium bromide (C14TAB), cetyltrimethylammonium bromide (C16TAB), and trimethyloctadecylammonium bromide (C18TAB). In some cases, the alkyltrimethylammonium bromide can be cetyltrimethylammonium bromide.

With continued reference to FIG. 2, the polymer can comprise polyethylene glycol (PEG). The polyethylene glycol can have a molecular weight of at least 10,000 g/mol. In some cases, the polyethylene glycol can have a molecular weight in a range of 10,000 g/mol to 35,000 g/mol. The solvent can comprise water or a water-ethanol mixture. The surfactant and polymer mixture can be heated to 60 degrees Celsius for less than 2 minutes to dissolve the components, forming a PEG/CTAB solution.

A silica precursor can be added to the solution. The silica precursor can comprise tetraethyl orthosilicate (TEOS) in liquid form. A condensation catalyst can be added to the solution to form a silica gel. The condensation catalyst can comprise ammonium hydroxide (NH₄OH) in aqueous form. The solution can be mixed for 15 minutes at room temperature following addition of the silica precursor and condensation catalyst. The silica can precipitate and self-assemble with the surfactant during mixing. The polymer can undergo phase segregation through spinodal decomposition simultaneously with the silica precipitation.

As further shown in FIG. 2, the silica gel can be subjected to hydrothermal treatment. The hydrothermal treatment can be performed at a temperature in a range of 80 °C to 120 °C for a duration of 12 hours to 48 hours. In some cases, the hydrothermal treatment can be performed at 100 degrees Celsius for 24 hours. The silica gel can be transferred to an autoclave for the hydrothermal treatment. The hydrothermal treatment can produce a reacted silica powder.

The reacted silica powder can be washed and dried. The reacted silica powder can be transferred and subjected to a 30-minute water wash, yielding a washed silica powder. The washed silica powder can be dried at 100 degrees Celsius for 24 hours to produce a dried silica powder.

The dried silica powder can be calcined to remove the surfactant and the polymer, thereby producing a hierarchical porous silica material having mesopores templated by the surfactant and macropores templated by the polymer. The calcination can be performed at 550 degrees Celsius for 5 hours. The calcination can decompose and remove the polyethylene glycol and alkyltrimethylammonium bromide templates, leaving open mesopores and macropores in the silica framework.

The molar ratio of reagents in the synthesis can be approximately 1 CₙTAB:0.02 PEG:5.4 TEOS:4.1-13.7 NH₄OH:320-480 H₂O:0.5-0 CH₃CH₂OH for producing hierarchical porous silica with controlled mesopore and macropore properties. The amount of ammonium hydroxide condensation catalyst can be varied within the range of 4.1 to 13.7 moles relative to 1 mole of surfactant to control the mesopore volume and pore size distribution of the final material. Higher amounts of ammonium hydroxide can produce materials with higher pore volumes and narrower pore size distributions.

The one-pot synthesis method can be completed within 48 hours when accounting for the dissolution step, hydrothermal treatment, washing, drying, and calcination. The one-pot synthesis method can eliminate the aging step, neutralization step, and acidification step of the prior art synthesis process. The one-pot synthesis method can also reduce the number of container transfers compared to the prior art synthesis process.

The synthesis can be scaled from small batch to large batch while maintaining consistent mesopore and macropore properties. Small batch synthesis can produce approximately 3.5 g of silica. Large batch synthesis can produce approximately 100 g of silica per batch by multiplying reagent amounts by a factor of approximately 30×. Multiple large batches can be combined to produce kilogram-scale quantities of hierarchical porous silica material. The scalability of the one-pot synthesis method can enable production of hierarchical porous silica materials for commercial applications.

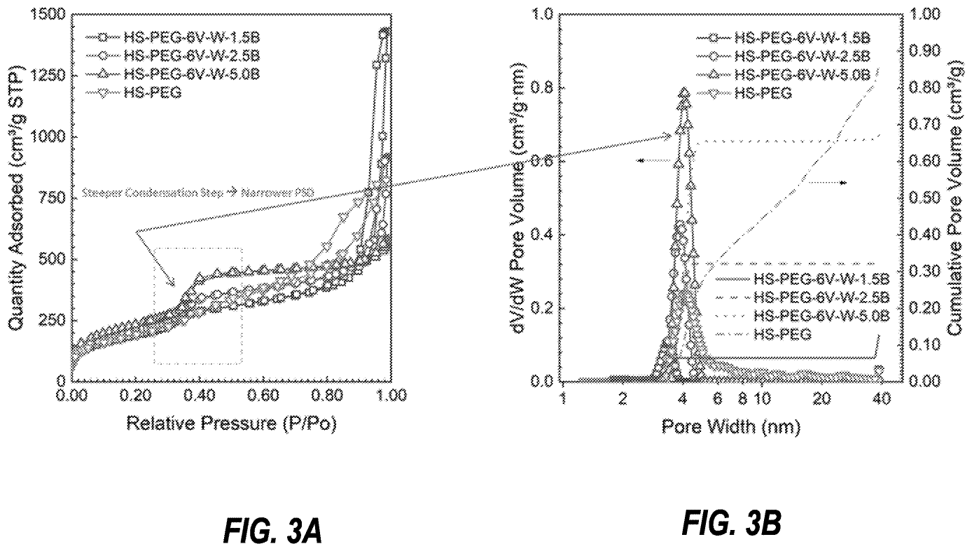

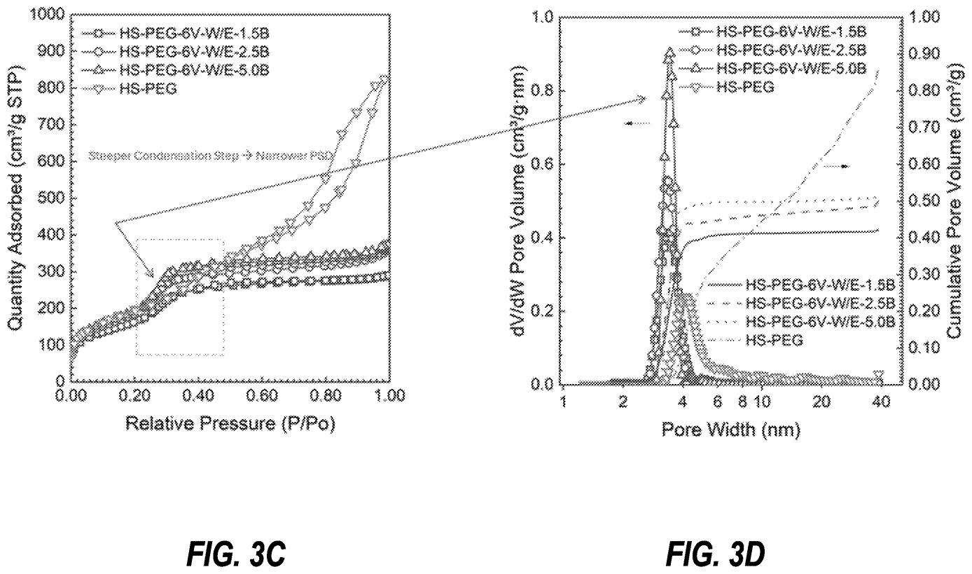

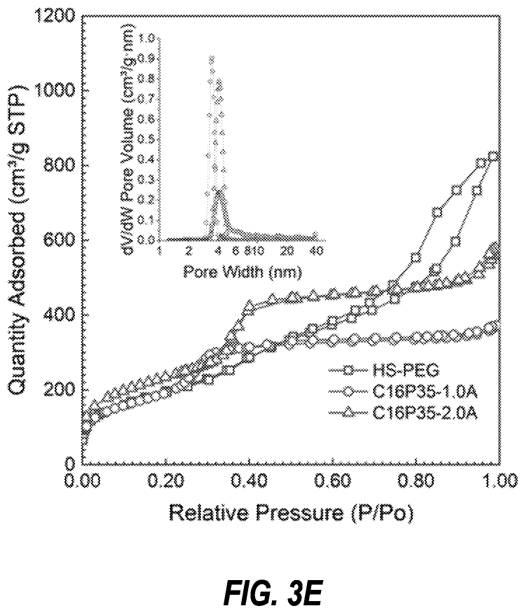

Referring to FIG. 3A, nitrogen adsorption-desorption isotherms and corresponding pore size distribution curves for hierarchical silica materials prepared using different amounts of ammonium hydroxide condensation catalyst in a water solvent system are depicted. The isotherms display Type IV characteristics with capillary condensation steps occurring at relative pressures between approximately 0.20 and 0.60, indicating the presence of mesopores. Four samples are represented, including HS-PEG-6V-W-1.5B, HS-PEG-6V-W-2.5B, HS-PEG-6V-W-5.0B, and a reference HS-PEG material prepared using the prior art synthesis process.

The steepness of the capillary condensation step can correlate with the width of the pore size distribution. A steeper condensation step can indicate a narrower pore size distribution. As shown in FIG. 3A, the HS-PEG-6V-W-5.0B sample prepared with the highest amount of ammonium hydroxide condensation catalyst exhibits the steepest condensation step among the samples prepared using the one-pot synthesis method. The pore size distribution curves in the right panel of FIG. 3A demonstrate that the HS-PEG-6V-W-5.0B sample exhibits a sharp, narrow peak centered between approximately 3 nm and 4 nm, indicating a well-defined and uniform mesopore structure.

With continued reference to FIG. 3A, the cumulative pore volume curves demonstrate that the majority of the pore volume is associated with the primary mesopore size range. The HS-PEG-6V-W-5.0B sample exhibits the highest total mesopore volume and the narrowest pore size distribution among the samples prepared with varying amounts of ammonium hydroxide catalyst. By increasing the amount of ammonium hydroxide condensation catalyst, the pore volume can increase and the pore size distribution can become narrower.

Referring to FIG. 3C, nitrogen adsorption-desorption isotherms and corresponding pore size distribution curves for hierarchical silica materials prepared using different amounts of ammonium hydroxide condensation catalyst in a water-ethanol solvent system are depicted. The solvent system can comprise water only or a water-ethanol mixture. The water-ethanol mixture can produce materials with smaller mesopores and lower pore volumes compared to water-only systems.

As shown in FIG. 3C, the isotherms for materials prepared in the water-ethanol solvent system display Type IV characteristics with condensation steps occurring at relative pressures around 0.30 to 0.40. The condensation steps occur at lower relative pressures compared to the water-only system shown in FIG. 3A, indicating smaller mesopore sizes. The pore size distribution curves in FIG. 3C demonstrate narrow, unimodal distributions centered between approximately 3.0 nm and 3.5 nm, with the cumulative pore volume curves showing that the majority of the pore volume is associated with this narrow mesopore size range.

The materials prepared in the water-ethanol solvent system exhibit lower total pore volumes compared to materials prepared in the water-only solvent system. The effect of the ammonium hydroxide condensation catalyst amount follows the same trend in both solvent systems, where higher amounts of ammonium hydroxide produce materials with higher pore volumes and narrower pore size distributions.

Referring to FIG. 3E, nitrogen adsorption-desorption isotherms and corresponding pore size distribution curves for hierarchical silica materials prepared using nitric acid as the condensation catalyst are depicted. The condensation catalyst can comprise an inorganic acid such as hydrochloric acid (HCl) or nitric acid (HNO₃) instead of ammonium hydroxide, particularly when using triblock copolymer surfactants as the mesophase templating agent.

As shown in FIG. 3E, three samples are represented, including an HS-PEG sample prepared using ammonium hydroxide and two samples designated C16P35-1.0A and C16P35-2.0A prepared using nitric acid at different concentrations. The HS-PEG sample prepared using ammonium hydroxide demonstrates the highest nitrogen uptake, reaching approximately 1100 cubic centimeters per gram at saturation. The C16P35-1.0A and C16P35-2.0A samples prepared using nitric acid show progressively lower uptakes of approximately 850 and 500 cubic centimeters per gram, respectively.

The inset in FIG. 3E displays the pore size distribution curves for the three samples. The HS-PEG sample prepared using ammonium hydroxide exhibits a sharp, narrow peak centered at approximately 4 nm, indicating a well-defined and uniform mesopore structure. The C16P35-1.0A and C16P35-2.0A samples prepared using nitric acid show broader pore size distributions with lower peak intensities. The broader pore size distributions indicate that acid-catalyzed synthesis conditions can result in less uniform mesopore structures compared to base-catalyzed synthesis when using alkyltrimethylammonium bromide surfactants as the mesophase templating agent.

By increasing the amount of nitric acid from the C16P35-1.0A synthesis to the C16P35-2.0A synthesis, the pore volume and pore width of the final silica can increase. However, the pore size distributions remain broader compared to materials prepared using ammonium hydroxide as the condensation catalyst. The selection of condensation catalyst can therefore affect both the mesopore volume and the uniformity of the mesopore structure in the hierarchical porous silica materials.

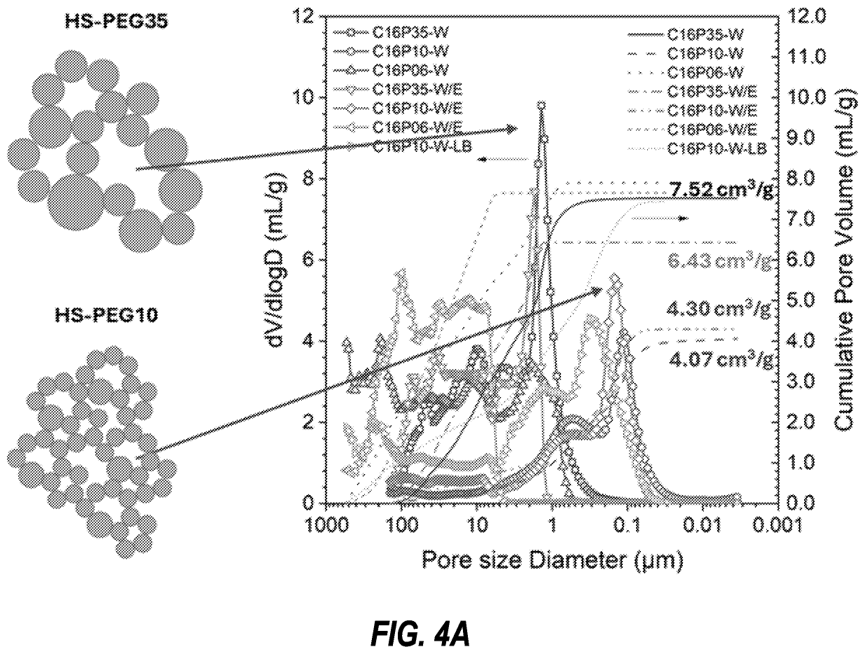

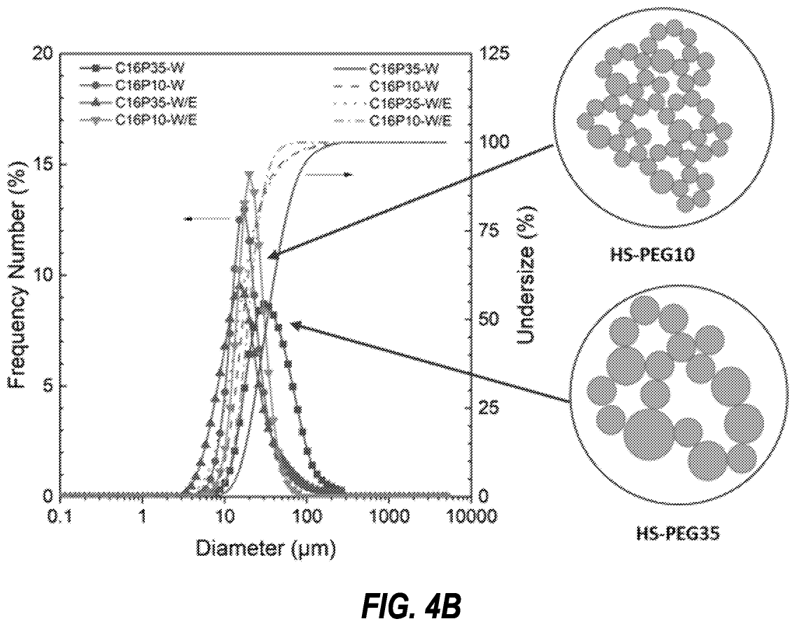

Referring to FIG. 4A, mercury intrusion porosimetry data and pore size distribution curves for hierarchical silica samples prepared using different molecular weight polyethylene glycol polymers and solvent systems are depicted. The graph includes differential pore volume on the left vertical axis and cumulative pore volume on the right vertical axis, both plotted against pore size diameter on a logarithmic scale ranging from 0.001 μm to 1000 μm. Multiple data series are plotted corresponding to samples labeled C16P35-W, C16P10-W, C16P06-W, C16P35-W/E, C16P10-W/E, C16P06-W/E, and C16P10-W-LB, where the numerical designation following P indicates the molecular weight of the polyethylene glycol polymer in thousands of grams per mole, W indicates water solvent, W/E indicates water-ethanol solvent mixture, and LB indicates large batch synthesis.

The hierarchical porous silica material can comprise a silica framework defining a plurality of mesopores and a plurality of macropores. As described previously, the mesopores can have a pore width in a range of 2 nm to 11 nm. The macropores can have a pore diameter in a range of 0.1 μm to 100 μm. In some cases, the macropores can have a pore diameter in a range of 0.1 μm to 10 μm. The macropores can be formed by aggregation of primary silica particles through a spinodal decomposition mechanism during synthesis.

With continued reference to FIG. 4A, the molecular weight of the polyethylene glycol polymer can control the macropore size in the hierarchical porous silica material. The polyethylene glycol polymer can template the primary particle size and consequently the primary particle aggregates. The primary particle aggregates can dictate the macropore size and volume. During synthesis, silica/surfactant domains and polyethylene glycol domains can phase segregate through spinodal decomposition. After calcination, the polyethylene glycol can evaporate and decompose to leave a structure of aggregated primary silica particles, while the surfactant can leave primary mesopores within the particle walls.

As shown in FIG. 4A, samples prepared using PEG with a molecular weight of 10,000 g/mol (P10) can yield macropores of approximately 100 nm to 200 nm, while samples prepared using PEG with a molecular weight of 35,000 g/mol (P35) can yield macropores of approximately 1000 nm to 3000 nm. Samples prepared using PEG with a molecular weight of 6,000 g/mol (P06) do not exhibit templated macropores, indicating that the molecular weight of 6,000 g/mol can be below the threshold for macropore templating through spinodal decomposition. The water-ethanol solvent system can produce materials with slightly larger macropores compared to the water-only solvent system.

The silica framework can have a total pore volume including mesopores and macropores in a range of 4 cm³/g to 8 cm³/g. As annotated in FIG. 4A, the cumulative pore volume values for selected samples include 7.52 cm³/g, 6.43 cm³/g, and 4.07 cm³/g. The total pore volume can vary depending on the molecular weight of the polyethylene glycol polymer and the solvent system used during synthesis.

Two schematic illustrations are positioned to the left of the graph in FIG. 4A, labeled HS-PEG35 and HS-PEG10, depicting spherical particle arrangements that represent the primary particle size and aggregation behavior resulting from the different molecular weight polyethylene glycol templates. The HS-PEG35 schematic shows larger particles with larger interparticle voids, while the HS-PEG10 schematic shows smaller particles with correspondingly smaller interparticle voids. The relationship between the polyethylene glycol molecular weight and the resulting macropore size distribution can be understood through the spinodal decomposition mechanism, where higher molecular weight polymers can produce larger phase-segregated domains and consequently larger primary particles and macropores.

Referring to FIG. 4B, particle size distribution analysis comparing hierarchical silica samples prepared using different polyethylene glycol molecular weights and solvent systems is depicted. The graph includes frequency number expressed as a percentage on the left vertical axis and undersize expressed as a percentage on the right vertical axis, with diameter in micrometers on a logarithmic horizontal axis ranging from 0.1 μm to 10000 μm. Four sample curves are presented, identified as C16P35-W, C16P10-W, C16P35-W/E, and C16P10-W/E.

The primary silica particles can have a secondary aggregate particle size in a range of 10 μm to 35 μm. As shown in FIG. 4B, the frequency distribution curves show peaks centered around 10 μm to 100 μm for all samples, with the cumulative undersize curves rising from near zero at small diameters to approximately 100 percent at larger diameters. The samples exhibit comparable median particle sizes of approximately 14 μm to 19 μm, with the largest agglomerate size observed for the HS-PEG35-5.0B-W sample at approximately 32.9 μm.

With continued reference to FIG. 4B, two circular inset diagrams are positioned above the graph, labeled HS-PEG10 and HS-PEG35, which schematically illustrate the difference in primary particle size between samples prepared with lower molecular weight PEG10 and higher molecular weight PEG35. The HS-PEG10 inset shows smaller, more numerous spherical particles, while the HS-PEG35 inset depicts larger spherical particles with greater size variation. While the overall secondary aggregate particle sizes can be comparable across samples prepared with different polyethylene glycol molecular weights, the primary particle size can change and directly affect the macropore size. The macropores can result from the primary silica particles forming intergrown particle structures that characterize the secondary particle structure.

The large batch sample designated C16P10-LB in FIG. 4A demonstrates that the macropore structure can be replicated when scaling the synthesis from small batch to large batch. The macropores of the large batch sample can be comparable to small batch materials, demonstrating the scalability of the one-pot synthesis method for producing hierarchical porous silica materials with controlled macropore properties. Control over macropore size can facilitate coating of surfaces for integration with water harvesting and water-carbon dioxide capture devices, as finer aggregates and smaller macropore sizes can be advantageous for such applications.

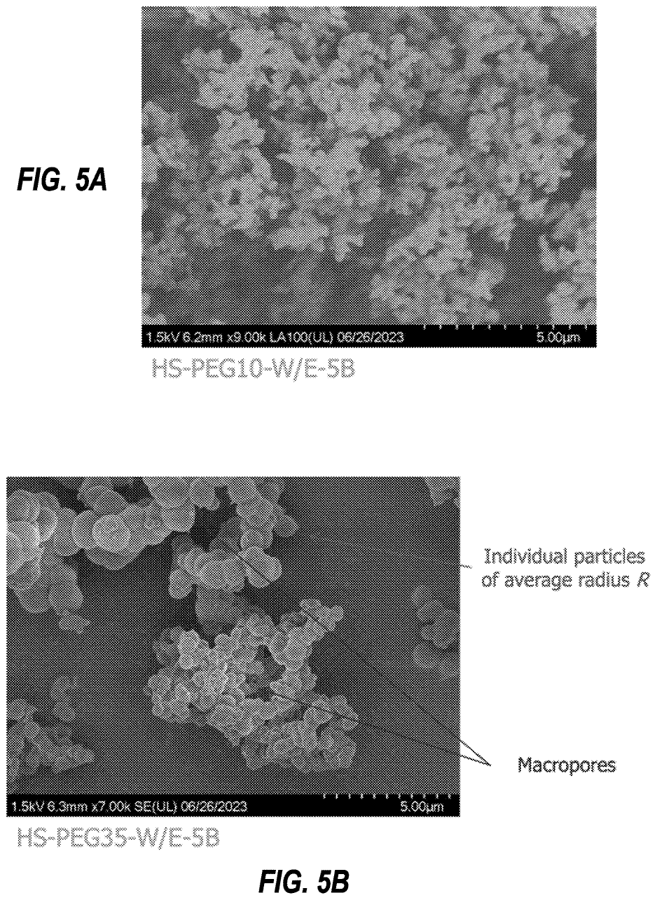

Referring to FIGS. 5A-5B, scanning electron microscope (SEM) images comparing two hierarchical porous silica samples prepared using different molecular weight polyethylene glycol polymers are depicted. FIG. 5A shows the HS-PEG10-W/E-5B sample, which was prepared using polyethylene glycol with a molecular weight of 10,000 g/mol. FIG. 5B shows the HS-PEG35-W/E-5B sample, which was prepared using polyethylene glycol with a molecular weight of 35,000 g/mol. Both images were captured at comparable magnifications with scale bars indicating 5.00 micrometers, using an accelerating voltage of 1.5 kV.

As shown in FIG. 5A, the HS-PEG10-W/E-5B sample exhibits a structure composed of aggregated primary particles that form a continuous mesoporous silica framework. The particles exhibit a rough, irregular morphology with relatively small primary particle sizes. The smaller primary particle sizes can result in smaller macropores between the particle aggregates. The macropores visible in FIG. 5A can correspond to the pore size distribution data shown in FIG. 4A, where samples prepared using PEG with a molecular weight of 10,000 g/mol exhibit macropores of approximately 100 nm to 200 nm.

With continued reference to FIG. 5B, the HS-PEG35-W/E-5B sample displays individual particles that are larger and more spherical compared to the particles shown in FIG. 5A. The higher molecular weight polyethylene glycol template can produce larger primary particles that aggregate to form a hierarchical structure with larger macropores visible between the particle clusters. The larger macropores visible in FIG. 5B can correspond to the pore size distribution data shown in FIG. 4A, where samples prepared using PEG with a molecular weight of 35,000 g/mol exhibit macropores of approximately 1000 nm to 3000 nm.

The comparison between FIGS. 5A and 5B demonstrates that the molecular weight of the polyethylene glycol polymer template can control the primary particle size through spinodal decomposition, which in turn can dictate the macropore size and volume in the final hierarchical silica material. Lower molecular weight polyethylene glycol can produce smaller primary particles and consequently smaller macropores, while higher molecular weight polyethylene glycol can yield larger primary particles and larger macropores in the resulting hierarchical porous structure. The silica walls visible in both FIGS. 5A and 5B can contain the primary mesopores templated by the surfactant, while the voids between the aggregated particles can constitute the macropores templated by the polyethylene glycol polymer.

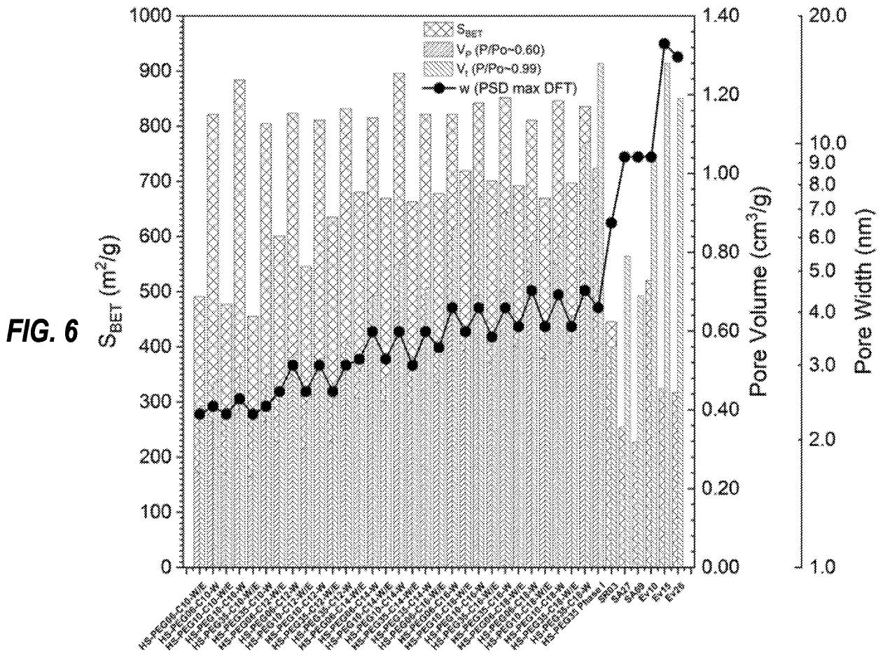

Referring to FIG. 6, a bar chart comparing adsorption properties of various HS-PEG materials and commercial silica support materials is depicted. The chart displays three parameters for each material sample: BET surface area measured in square meters per gram, pore volume at a relative pressure of 0.60, and total pore volume at a relative pressure of 0.99, both measured in cubic centimeters per gram. A fourth parameter shown as a connected line with filled circles represents the pore width determined from the maximum of the pore size distribution calculated by density functional theory, measured in nanometers.

The silica framework of the hierarchical porous silica materials can have a BET surface area greater than 400 m²/g. As shown in FIG. 6, the HS-PEG materials prepared using the one-pot synthesis method exhibit BET surface areas that exceed 400 m²/g across the various synthesis conditions investigated. The BET surface area can vary depending on the surfactant chain length, polyethylene glycol molecular weight, solvent system, and amount of condensation catalyst used during synthesis.

With continued reference to FIG. 6, the silica framework can have a BET surface area in a range of 600 m²/g to 900 m²/g. The hierarchical porous silica materials prepared using alkyltrimethylammonium bromide surfactants with different alkyl chain lengths, including C10TAB, C12TAB, C14TAB, C16TAB, and C18TAB, exhibit BET surface areas within this range. The bar chart demonstrates that the HS-PEG materials can achieve comparable or higher BET surface areas compared to commercial silica supports while also providing controlled mesopore and macropore structures.

As further shown in FIG. 6, the pore volume at a relative pressure of 0.60 and the total pore volume at a relative pressure of 0.99 can vary across the different HS-PEG formulations and reference materials. The pore volume at a relative pressure of 0.60 can correspond to the mesopore volume, while the total pore volume at a relative pressure of 0.99 can include contributions from both mesopores and larger pores. The pore width data points connected by a line demonstrate variation across the different material samples, showing how mesopore size changes with different synthesis conditions and surfactant chain lengths used in the preparation of the hierarchical silica materials.

The hierarchical porous silica materials can exhibit mesopore widths ranging from approximately 2 nm to 5 nm when prepared using alkyltrimethylammonium bromide surfactants with alkyl chain lengths from C10 to C18. The systematic increase in pore width with increasing surfactant chain length, as described previously with reference to FIGS. 3A-3E, can be observed in the pore width data presented in FIG. 6. The combination of high BET surface area, controlled mesopore volume, and tunable pore width can provide hierarchical porous silica materials suitable for use as sorbent supports in atmospheric water generation, thermal energy storage, and gas separation applications.

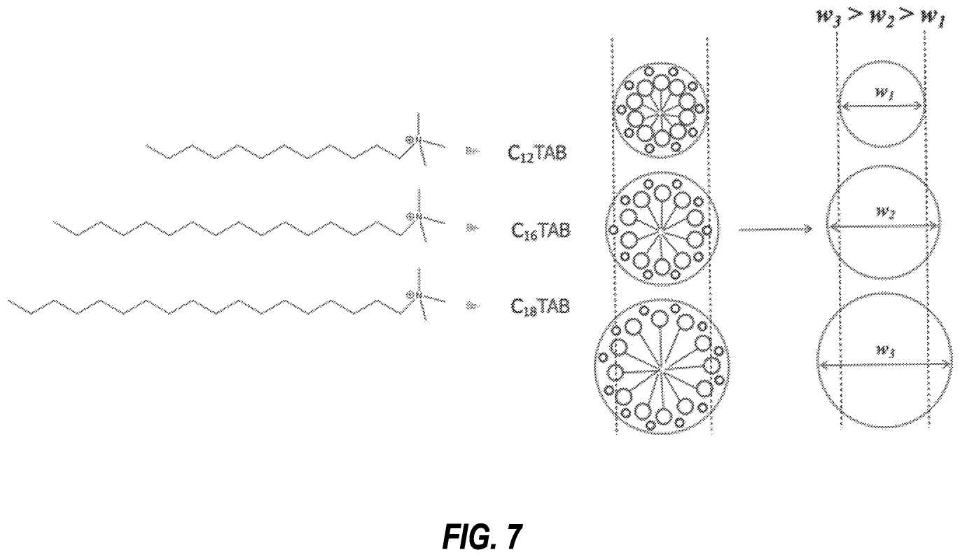

Referring to FIG. 7, a schematic illustration showing the relationship between alkyltrimethylammonium bromide surfactant chain length and resulting silica mesopore width is depicted. Three surfactant molecules are shown at the bottom of the figure, labeled as C12TAB, C16TAB, and C18TAB from left to right. Each surfactant molecule comprises a positively charged quaternary ammonium headgroup with three methyl substituents and a bromide counterion, attached to alkyl chains of increasing length corresponding to 12, 16, and 18 carbon atoms respectively.

As shown in FIG. 7, above each surfactant molecule, a circular cross-sectional representation shows the self-assembled micelle structure. The surfactant molecules can arrange radially with their hydrophobic tails pointing inward and their charged headgroups facing outward. The top portion of FIG. 7 displays three circles representing the cross-sections of the templated mesopores, with diameters labeled as W1, W2, and W3 from left to right. The pore widths can increase progressively with increasing surfactant chain length, as indicated by the relationship W3 greater than W2 greater than W1 shown in the upper left corner of the figure.

With continued reference to FIG. 7, the mesopore width can be controlled by selecting alkyltrimethylammonium bromide surfactants with different alkyl chain lengths. The alkyl chain length can determine the size of the micelles formed during self-assembly, which in turn can dictate the final mesopore dimensions in the silica framework after template removal. The mesopores can have a pore width in a range of 2 nm to 6 nm when using alkyltrimethylammonium bromide surfactants with alkyl chain lengths from C10 to C18. In some cases, the mesopores can have a pore width in a range of 3 nm to 5 nm.

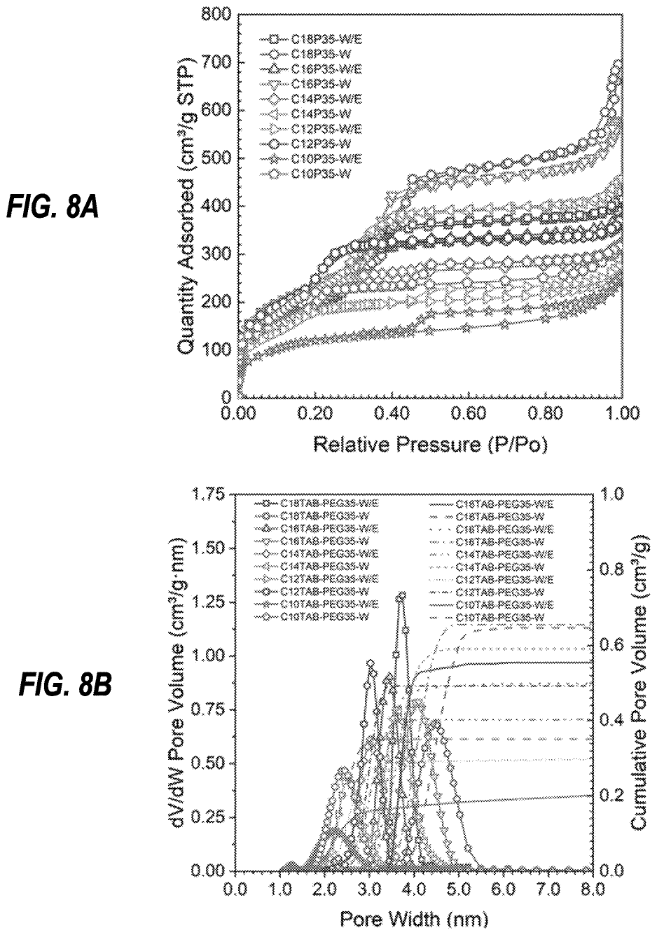

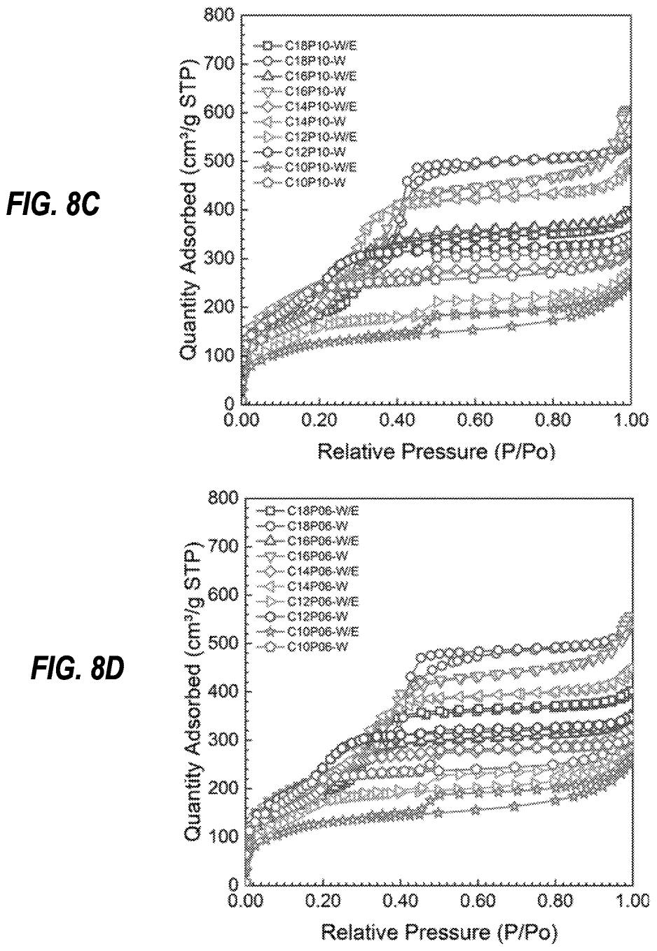

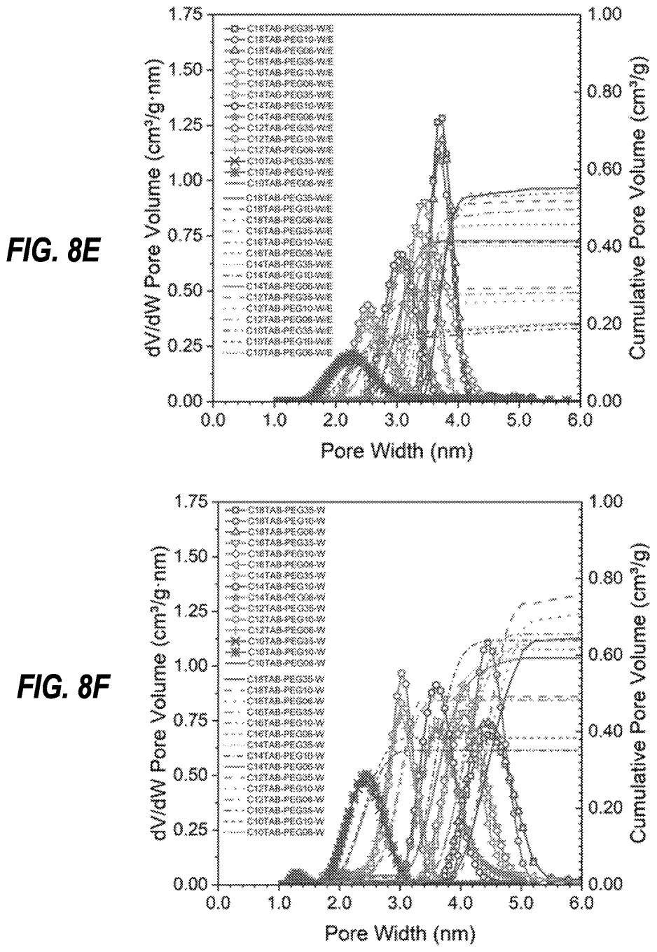

Referring to FIG. 8A, nitrogen adsorption-desorption isotherms and corresponding pore size distribution curves for hierarchical silica materials prepared using different alkyltrimethylammonium bromide surfactants with varying alkyl chain lengths and polyethylene glycol templates are depicted. The upper panel shows quantity adsorbed in cubic centimeters per gram at standard temperature and pressure plotted against relative pressure for ten different samples. The samples include C18P35-W/E, C18P35-W, C16P35-W/E, C16P35-W, C14P35-W/E, C14P35-W, C12P35-W/E, C12P35-W, C10P35-W/E, and C10P35-W, where the notation indicates the surfactant chain length, polyethylene glycol molecular weight of 35,000 g/mol, and solvent system used during synthesis.

As shown in FIG. 8A, the isotherms exhibit Type IV characteristics with capillary condensation steps that shift systematically toward higher relative pressures as the surfactant alkyl chain length increases from C10 to C18. The shift in the capillary condensation step position can correspond to an increase in mesopore width with increasing surfactant chain length, consistent with the schematic representation in FIG. 7. Materials prepared in water-only solvent systems can show higher nitrogen uptakes and condensation steps at slightly higher relative pressures compared to materials prepared in water-ethanol mixtures.

With continued reference to FIG. 8A, the lower panel displays differential pore volume in cubic centimeters per gram per nanometer on the left vertical axis and cumulative pore volume in cubic centimeters per gram on the right vertical axis, both plotted against pore width in nanometers. The pore size distribution curves demonstrate narrow, unimodal distributions with peak positions that increase progressively with increasing surfactant chain length. The C10-based materials can exhibit pore widths centered near 2.5 nm, while C18-based materials can show pore widths centered near 4.0 nm to 4.5 nm. The cumulative pore volume curves confirm that materials prepared in water can achieve higher total pore volumes than their water-ethanol counterparts across all surfactant chain lengths investigated. The silica framework can have a mesopore volume in a range of 0.3 cm³/g to 1.1 cm³/g depending on the synthesis conditions.

Referring to FIGS. 8C-8D, nitrogen adsorption-desorption isotherms at 77 K for hierarchical silica materials prepared using different alkyltrimethylammonium bromide surfactants and polyethylene glycol templates with molecular weights of 10,000 g/mol and 6,000 g/mol are depicted. FIG. 8C shows isotherms for materials synthesized with polyethylene glycol having a molecular weight of 10,000 g/mol, while FIG. 8D shows isotherms for materials synthesized with polyethylene glycol having a molecular weight of 6,000 g/mol.

As shown in FIG. 8C, the isotherms for materials prepared with PEG10 exhibit Type IV characteristics with capillary condensation steps that shift systematically toward higher relative pressures as the surfactant alkyl chain length increases from C10 to C18. The samples include C18P10-W/E, C18P10-W, C16P10-W/E, C16P10-W, C14P10-W/E, C14P10-W, C12P10-W/E, C12P10-W, C10P10-W/E, and C10P10-W. The systematic shift in condensation step position with surfactant chain length can be comparable to the behavior observed for PEG35 materials in FIG. 8A, indicating that the mesopore size can be controlled independently of the polyethylene glycol molecular weight.

With continued reference to FIG. 8D, the isotherms for materials prepared with PEG06 exhibit similar Type IV characteristics with capillary condensation steps that shift systematically with surfactant chain length. The samples include C18P06-W/E, C18P06-W, C16P06-W/E, C16P06-W, C14P06-W/E, C14P06-W, C12P06-W/E, C12P06-W, C10P06-W/E, and C10P06-W. The primary mesopores can remain unaffected by the polyethylene glycol template molecular weight, as the mesopore size can be determined by the surfactant chain length while the macropore size can be determined by the polyethylene glycol molecular weight. Small variations in the total mesopore volume can result from the systematic decrease in primary particle size with decreasing molecular weight of the polyethylene glycol.

Referring to FIGS. 8E-8F, pore size distribution data for hierarchical porous silica materials prepared using different combinations of alkyltrimethylammonium bromide surfactants and polyethylene glycol polymers are depicted. FIG. 8E corresponds to materials synthesized in a water-ethanol solvent system, while FIG. 8F corresponds to materials synthesized in water only as the solvent. Both graphs display pore width in nanometers on the horizontal axis ranging from 0.0 nm to 6.0 nm, differential pore volume in cubic centimeters per gram per nanometer on the left vertical axis, and cumulative pore volume in cubic centimeters per gram on the right vertical axis.

As shown in FIG. 8E, the differential pore volume curves for materials prepared in the water-ethanol solvent system appear as peaked distributions showing the primary mesopore sizes templated by each surfactant. The pore size distribution peaks occur at lower pore widths compared to the water-only system shown in FIG. 8F, demonstrating that the solvent composition can affect the resulting mesopore dimensions. The systematic shift in peak positions from smaller to larger pore widths corresponds to increasing surfactant alkyl chain length from C10 to C18.

With continued reference to FIG. 8F, the differential pore volume curves for materials prepared in the water-only solvent system demonstrate the ability to tune mesopore size within less than 1 nm at a time, and in the range of 2 nm to 5 nm. The narrow pore size distributions can be maintained regardless of the polyethylene glycol molecular weight used, as evidenced by the sharp peaks for materials prepared with PEG35, PEG10, and PEG06. The cumulative pore volume curves appear as step-like functions that plateau at higher pore widths, confirming that the majority of the pore volume can be associated with the narrow mesopore size range templated by the surfactant.

The alkyltrimethylammonium bromide surfactant can have an alkyl chain length of C20 or C22, which can yield mesopores of approximately 6 nm in size. Surfactants with C20 and C22 alkyl chain lengths can require the use of a smaller chain co-surfactant given that the micelles can grow beyond the coverage provided by the individual surfactant head groups. Alternatively, C20 and C22 surfactants having larger head groups can be used to accommodate the larger micelle sizes without requiring a co-surfactant.

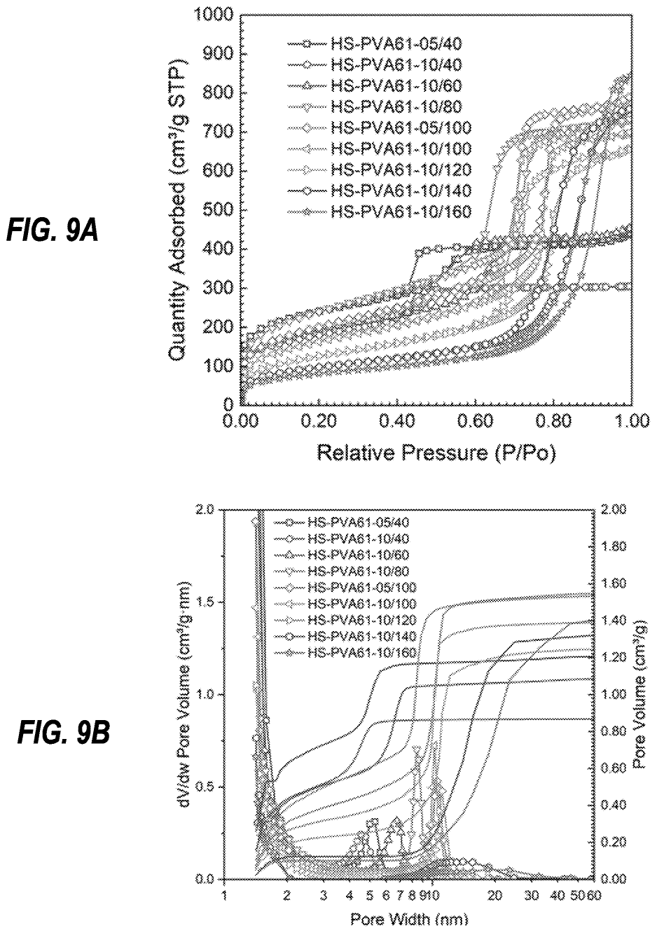

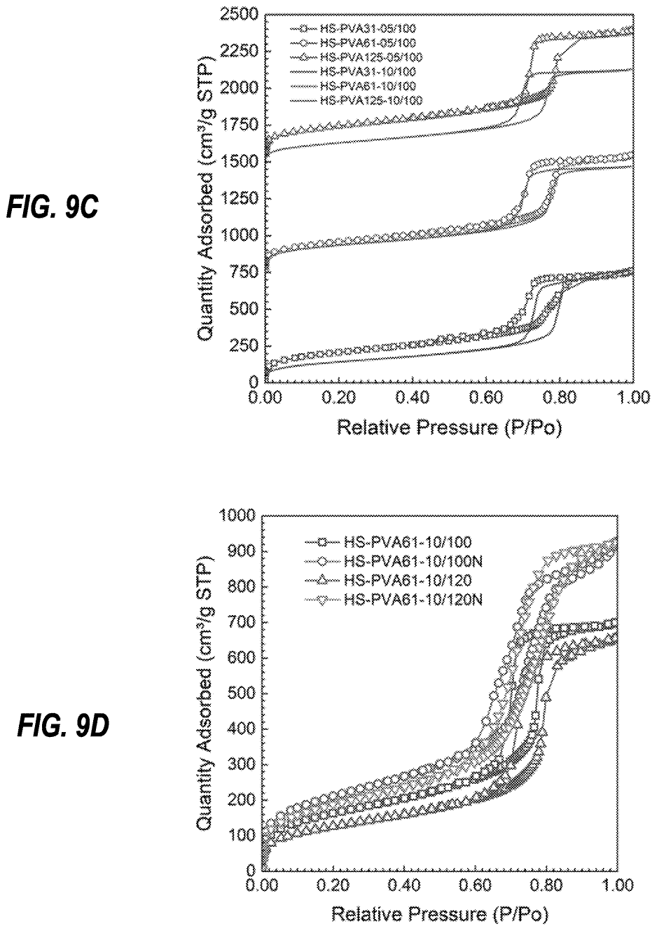

Referring to FIG. 9A, nitrogen adsorption-desorption isotherms at 77 K and corresponding pore size distribution curves for hierarchical silica materials prepared using P123 triblock copolymer and polyvinyl alcohol with a molecular weight of 61,000 g/mol are depicted. The hierarchical porous silica material can be prepared using triblock copolymer surfactants having the general formula poly(ethylene oxide)-poly(propylene oxide)-poly(ethylene oxide) (PEO-PPO-PEO) or poly(ethylene oxide)-poly(butylene oxide)-poly(ethylene oxide) (PEO-PBO-PEO) as the mesophase templating agent. Commercially available surfactants with these compositions include P123, F127, and VORASURF.

The upper panel of FIG. 9A shows quantity adsorbed in cubic centimeters per gram at standard temperature and pressure plotted against relative pressure from 0.00 to 1.00. Multiple samples are represented, including HS-PVA61-05/40, HS-PVA61-10/40, HS-PVA61-10/60, HS-PVA61-10/80, HS-PVA61-05/100, HS-PVA61-10/100, HS-PVA61-10/120, HS-PVA61-10/140, and HS-PVA61-10/160, where the numerical designations indicate the weight percentage of polyvinyl alcohol and the hydrothermal synthesis temperature in degrees Celsius. The macropore templating polymer can comprise polyvinyl alcohol (PVA) having molecular weights of 31,000 g/mol, 61,000 g/mol, or 125,000 g/mol as an alternative to polyethylene glycol for templating macropores in the hierarchical silica structure. The macropore templating polymer can also comprise polystyrene (PS) as an alternative to polyethylene glycol or polyvinyl alcohol for templating macropores in the hierarchical silica structure.

As shown in FIG. 9A, the isotherms exhibit Type IV characteristics with hysteresis loops, where the position of the capillary condensation step shifts toward higher relative pressures as the hydrothermal synthesis temperature increases. The shift in capillary condensation step position can indicate enlargement of mesopores with increasing hydrothermal synthesis temperature. The hydrothermal treatment temperature can be varied from 40 °C to 160 °C when using triblock copolymer surfactants. Higher hydrothermal synthesis temperatures can increase mesopore volume and decrease micropore volume. The mesopores can have a pore width in a range of 5 nm to 14 nm when using triblock copolymer surfactants as the mesophase templating agent, with larger mesopores obtainable through micelle expanders or tuning polystyrene amounts.

With continued reference to FIG. 9A, the lower panel displays the differential pore volume in cubic centimeters per gram per nanometer on the left vertical axis and cumulative pore volume in cubic centimeters per gram on the right vertical axis, both plotted against pore width in nanometers on a logarithmic scale ranging from 1 nm to 60 nm. The pore size distribution curves demonstrate that increasing hydrothermal synthesis temperature can result in larger mesopore diameters and increased mesopore volumes. Samples prepared at hydrothermal synthesis temperatures of 140 degrees Celsius and greater can exhibit broader pore size distributions compared to samples prepared at lower temperatures. The hierarchical porous silica material can comprise micropores interconnecting the primary mesopores when prepared using triblock copolymer surfactants, resulting in a triply hierarchical pore structure with micropores, mesopores, and macropores. Hydrothermal synthesis temperatures of 120 °C to 160 °C and higher can lead to elimination of the micropores, which can be enlarged to mesopores of the same size as the originally made primary mesopores.

Referring to FIGS. 9C-9D, nitrogen adsorption isotherms at 77 K for HS-PVA hierarchical silica materials prepared using P123 triblock copolymer and polyvinyl alcohol templates under various synthesis conditions are depicted. FIG. 9C shows isotherms for six different HS-PVA samples prepared with varying PVA molecular weights and loading percentages at a hydrothermal synthesis temperature of 100 °C, including HS-PVA31-05/100, HS-PVA61-05/100, HS-PVA125-05/100, HS-PVA31-10/100, HS-PVA61-10/100, and HS-PVA125-10/100. The weight ratio of PVA in the synthesis gel can be 5 wt % or 10 wt %. Both weight ratios can produce similar mesopore size and volume, but the higher PVA loads can result in lower micropore volumes.

As shown in FIG. 9C, the isotherms display Type IV characteristics with capillary condensation steps occurring at relative pressures between approximately 0.60 and 0.80, indicating the presence of uniform mesopores. The quantity adsorbed ranges from approximately 0 to 2500 cm³/g STP, with the different samples exhibiting varying total pore volumes as evidenced by the plateau heights at high relative pressures. The adsorption properties of the materials prepared using either 5 wt % and 10 wt % of each PVA can be similar, with comparable mesopore size and volume. An exception can be found for PVA31, where the 5 wt % ratio can result in less uniform mesopores, evidenced by a broader capillary condensation step compared to the sample from the 10 wt % PVA. In general, the samples prepared using the highest PVA loads can have lower micropore volumes, implying that PVA can influence the molecular self-assembly of silicate with P123.

With continued reference to FIG. 9D, isotherms for four HS-PVA61 samples prepared at 10 weight percent PVA loading under different hydrothermal temperatures and with different condensation catalysts are presented, specifically HS-PVA61-10/100, HS-PVA61-10/100N, HS-PVA61-10/120, and HS-PVA61-10/120N, where the N designation indicates samples prepared using nitric acid as the condensation catalyst instead of hydrochloric acid. The samples prepared with nitric acid catalyst can exhibit broader hysteresis loops and higher total pore volumes compared to their hydrochloric acid counterparts, indicating differences in mesopore structure and ordering. Changing the condensation catalyst from hydrochloric acid to other oxidizing acids such as nitric acid can produce materials that exhibit broad capillary condensation steps and higher total pore volumes, indicating disordered mesopore structure as indicated by the broad hysteresis loops. The hysteresis loops in both FIGS. 9C and 9D close at relative pressures around 0.40 to 0.50, consistent with the tensile strength effect characteristic of mesoporous materials with pore sizes in the range of several nanometers.

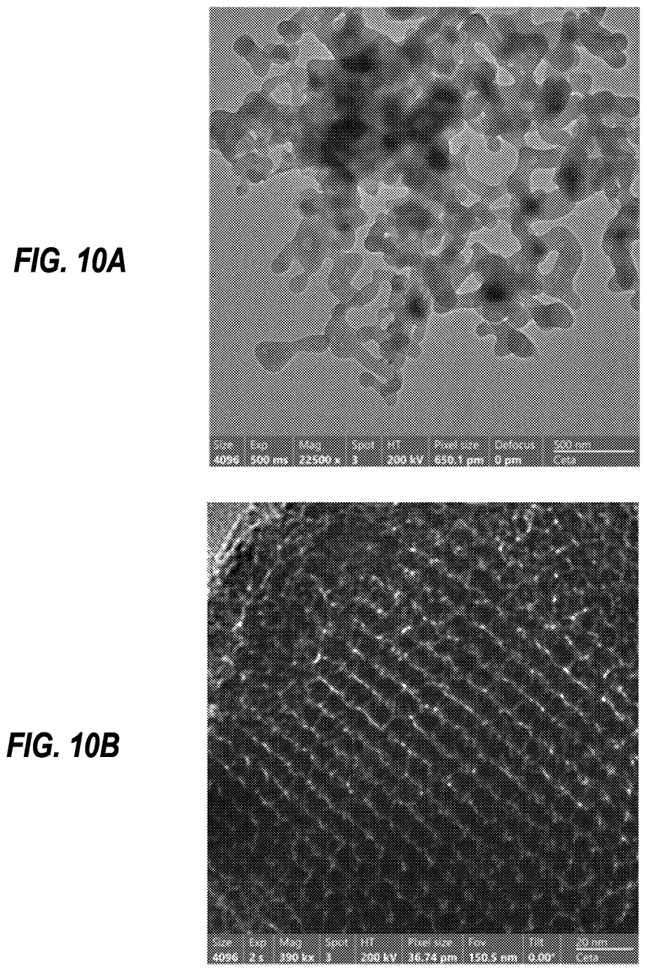

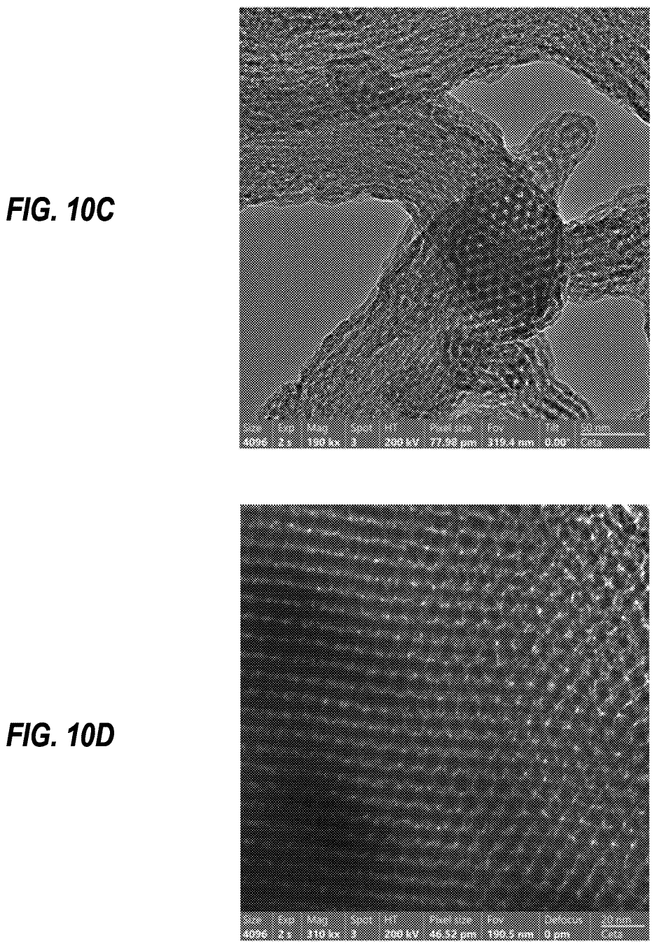

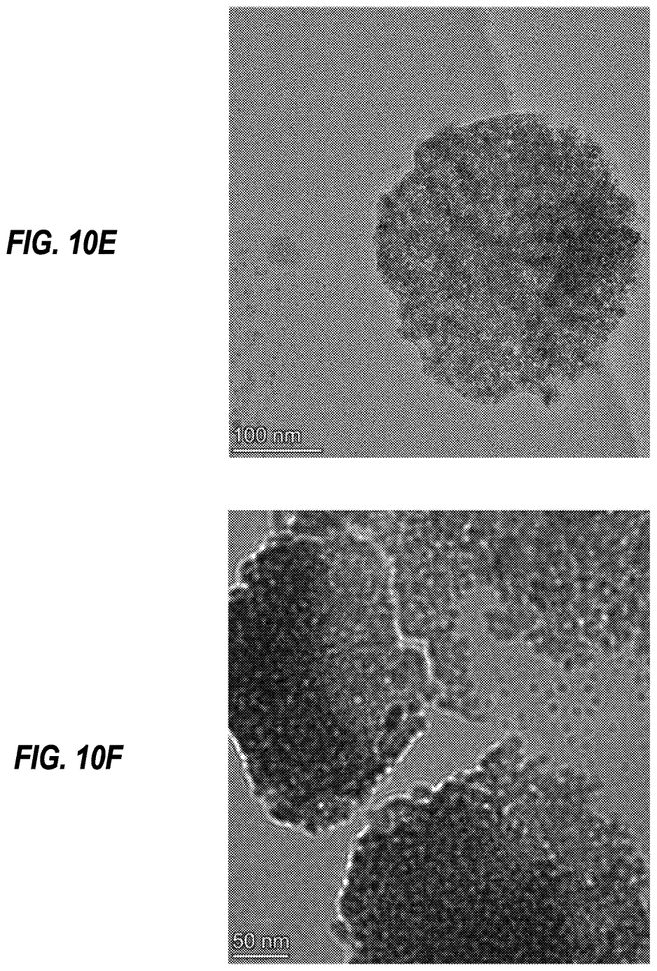

Referring to FIGS. 10A-10B, transmission electron microscopy (TEM) images of hierarchical porous silica materials at different magnifications are depicted. FIG. 10A shows a low magnification TEM image of silica particles with an interconnected, branching morphology. The particles exhibit a porous network structure with varying degrees of electron density, where darker regions indicate thicker or denser material and lighter regions correspond to pores or thinner sections. The scale bar in FIG. 10A indicates 500 nm, and the imaging parameters include a magnification of 22500× and an accelerating voltage of 200 kV.

As shown in FIG. 10B, a high magnification TEM image reveals the internal mesopore structure of the silica material. FIG. 10B displays a highly ordered arrangement of uniform cylindrical mesopores with long-range periodicity, appearing as parallel channels running through the silica framework. The regular spacing and alignment of the pores demonstrate the templated nature of the mesopore structure. The scale bar in FIG. 10B indicates 20 nm, and the imaging parameters include a magnification of 390 kx and an accelerating voltage of 200 kV. Together, FIGS. 10A and 10B illustrate the hierarchical pore architecture of the silica material, with the macroscale particle morphology visible in FIG. 10A and the nanoscale ordered mesopore channels visible in FIG. 10B.

Referring to FIGS. 10C-10D, transmission electron microscopy images of hierarchical porous silica materials at different magnifications are depicted. FIG. 10C shows a lower magnification TEM image captured at 190 kx magnification with a 200 kV accelerating voltage, displaying the overall morphology of the silica structure. The image reveals interconnected silica walls with visible mesoporous texture, showing the hierarchical arrangement of primary particles that form the macroporous network. The silica framework exhibits a continuous structure with voids between particle aggregates representing the macropore regions templated by the high molecular weight polymer during synthesis. The scale bar in FIG. 10C indicates 50 nm, and the field of view is approximately 319.4 nm.

With continued reference to FIG. 10D, a higher magnification TEM image captured at 310 kx magnification provides detailed visualization of the ordered mesopore structure within the silica walls. FIG. 10D reveals the periodic arrangement of cylindrical mesopores with uniform pore sizes, demonstrating the narrow pore size distribution achieved through surfactant templating. The regular pattern of light and dark regions corresponds to the mesopore channels and silica walls, respectively. The scale bar in FIG. 10D indicates 20 nm with a field of view of approximately 190.5 nm. FIGS. 10C and 10D demonstrate the dual-scale porosity of the hierarchical silica materials, with the lower magnification image showing the macroporous architecture formed by particle aggregation and the higher magnification image revealing the well-defined mesoporous structure within the silica framework that results from the liquid crystal templating mechanism.

Referring to FIGS. 10E-10F, transmission electron microscopy images of hierarchical porous silica materials prepared using polyvinyl alcohol as the macropore template are depicted. FIG. 10E shows a TEM image at a scale of 100 nm, displaying a single roughly spherical particle aggregate with a porous internal structure. The particle exhibits a textured appearance with varying contrast regions indicating the presence of mesopores distributed throughout the silica framework.

As shown in FIG. 10F, a higher magnification TEM image at a scale of 50 nm reveals multiple particle aggregates with visible internal porosity. The image displays the detailed mesoporous structure within the silica walls, with lighter regions corresponding to pore channels and darker regions corresponding to the silica framework. The particles exhibit irregular boundaries and interconnected porous networks characteristic of hierarchically structured silica materials prepared using polymer templating methods. The primary silica particles forming the hierarchical structure can have morphology resembling interconnected rods when prepared using polyvinyl alcohol as the macropore template with triblock copolymer surfactants. The formation of the macrostructure can proceed via a spinodal decomposition mechanism similar to that observed with polyethylene glycol polymers, where the polyvinyl alcohol templates the growth of particle structures that aggregate to form the hierarchical porous architecture. The mesopores within the silica walls can exhibit regions with periodic cylindrical mesopores coexisting with wormhole-type mesopores, depending on the synthesis conditions and the degree of ordering achieved during the self-assembly process.

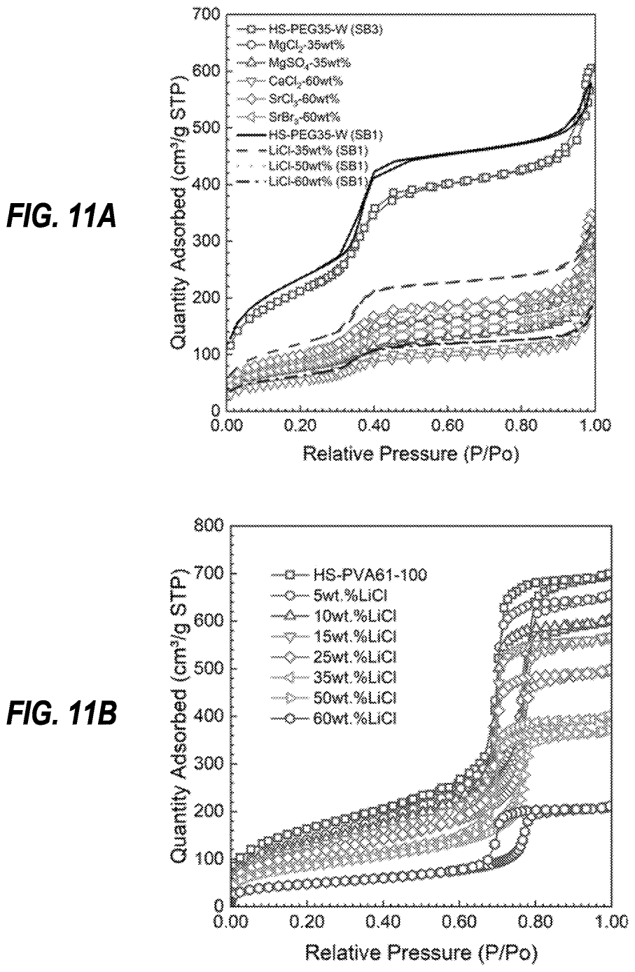

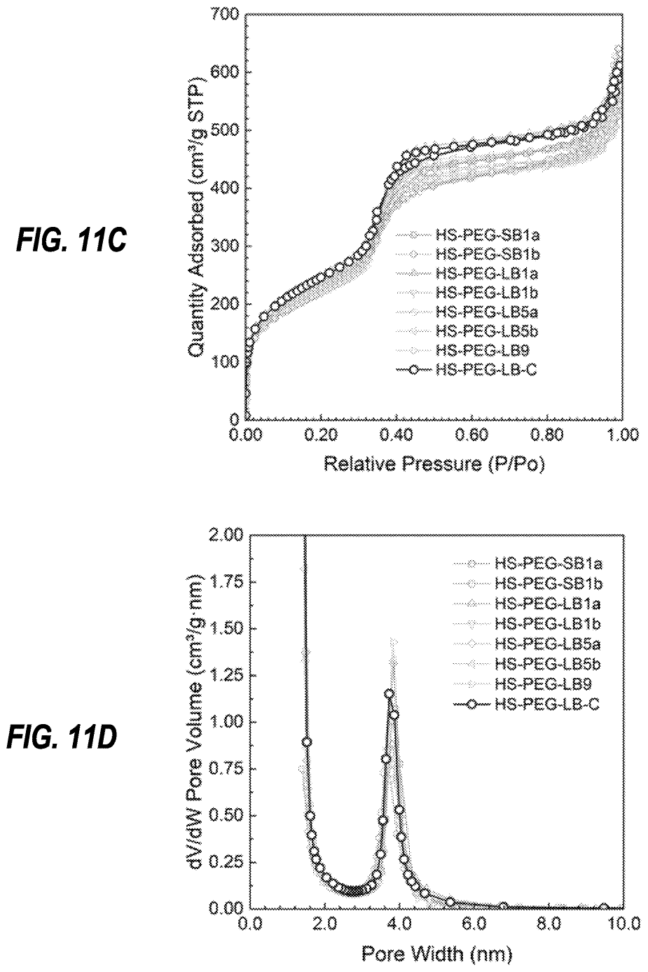

Referring to FIG. 11A, nitrogen adsorption-desorption isotherms at 77 K for hierarchical silica materials loaded with various hygroscopic salts are depicted. A composite sorbent can comprise a hierarchical porous silica support comprising mesopores having a pore width in a range of 2 nm to 11 nm and macropores having a pore diameter greater than 50 nm, and a hygroscopic salt disposed within the mesopores of the hierarchical porous silica support. The hygroscopic salt can be present in an amount of 5 wt % to 60 wt % based on a total weight of the composite sorbent.

As shown in FIG. 11A, multiple curves are represented corresponding to different salt-loaded silica composites including the bare HS-PEG35-W support prepared in two different synthesis batches designated SB1 and SB3, and composite sorbents loaded with MgCl₂ at 35 wt %, MgSO₄ at 35 wt %, CaCl₂ at 60 wt %, SrCl₂ at 60 wt %, SrBr₂ at 60 wt %, and LiCl at 35 wt %, 50 wt %, and 60 wt %. The isotherms demonstrate Type IV behavior with capillary condensation steps occurring at relative pressures between approximately 0.30 and 0.50, indicating the presence of uniform mesopores in the support materials. The quantity adsorbed ranges from 0 to approximately 700 cubic centimeters per gram at standard temperature and pressure.

With continued reference to FIG. 11A, the hygroscopic salt can comprise at least one salt selected from the group consisting of lithium chloride, lithium bromide, magnesium chloride, magnesium sulfate, calcium chloride, sodium chloride, potassium chloride, strontium chloride, and strontium bromide. The varying heights of the condensation steps in FIG. 11A reflect differences in total pore volume resulting from different salt loadings and salt types. As the salt loading increases, the total quantity adsorbed can systematically decrease, demonstrating progressive filling of the mesopore volume by the hygroscopic salt. The hygroscopic salt can comprise lithium chloride. The lithium chloride can be present in an amount of 35 wt % to 60 wt % based on the total weight of the composite sorbent, as demonstrated by the LiCl—35 wt %, LiCl—50 wt %, and LiCl—60 wt % samples shown in FIG. 11A.

The salt loading can be determined by the precursor used during impregnation. When anhydrous salts are used, a maximum loading of 35 wt % can be selected. For hydrated salt precursors, loadings of 50 wt % and 60 wt % can be chosen. The strontium salts SrCl₂ and SrBr₂ can be used in hexahydrate form, and even though 60 wt % loadings can be prepared, the final strontium amounts can correspond to a percentage between 30 wt % and 35 wt % if an anhydrous precursor had been used. The salt loads can be systematically increased, and the loading mechanism can be predominantly pore filling over pore lining independently of the mesopore size.

The two batches of the bare HS-PEG35-W support designated SB1 and SB3 in FIG. 11A exhibit similar nitrogen sorption isotherms, which confirms the silica synthesis method reproducibility. Small variations in the total pore volume can be expected from batch to batch.

Referring to FIGS. 11C-11D, nitrogen adsorption isotherms and pore size distribution curves for hierarchical porous silica materials prepared using different synthesis batches are depicted. FIG. 11C displays quantity adsorbed in cubic centimeters per gram at standard temperature and pressure on the vertical axis versus relative pressure on the horizontal axis. Multiple data series are shown representing different HS-PEG samples including HS-PEG-SB1a, HS-PEG-SB1b, HS-PEG-LB1a, HS-PEG-LB1b, HS-PEG-LB5a, HS-PEG-LB5b, HS-PEG-LB9, and HS-PEG-LB-C, where SB indicates small batch synthesis and LB indicates large batch synthesis. The isotherms exhibit Type IV characteristics with capillary condensation steps occurring at relative pressures between approximately 0.30 and 0.45, and the quantity adsorbed ranges from 0 to approximately 700 cubic centimeters per gram at standard temperature and pressure.

As shown in FIG. 11D, the pore size distribution curves present the differential pore volume in cubic centimeters per gram per nanometer on the vertical axis versus pore width in nanometers on the horizontal axis. The same sample series are represented, showing narrow pore size distribution peaks centered at approximately 3.5 nm to 4.0 nm, with peak heights reaching up to approximately 1.75 cubic centimeters per gram per nanometer. The data demonstrate reproducibility of the synthesis method across small batch and large batch preparations, with the combined large batch sample showing consistent mesopore characteristics compared to individual batch samples.

With continued reference to FIGS. 11C-11D, the small batch synthesis can produce approximately 3.5 g of silica, while each large batch sample can be prepared by a 30× scale to yield approximately 100 g of silica. The combined large batch material designated HS-PEG-LB-C can be obtained from the combination of twelve 100 g batches to produce 1.2 kg of hierarchical porous silica material. The adsorption and structural properties can be largely retained when scaling from small batch to large batch synthesis. The isotherms in FIG. 11C largely coincide, and the mesopore structure can be retained as verified by the pore size distribution data in FIG. 11D. The scalability of the synthesis process, even with non-optimized reactors in a research laboratory frame, can be demonstrated for producing systematically the same mesoporous-macroporous hierarchical structure suitable for use as the hierarchical porous silica support in composite sorbents.

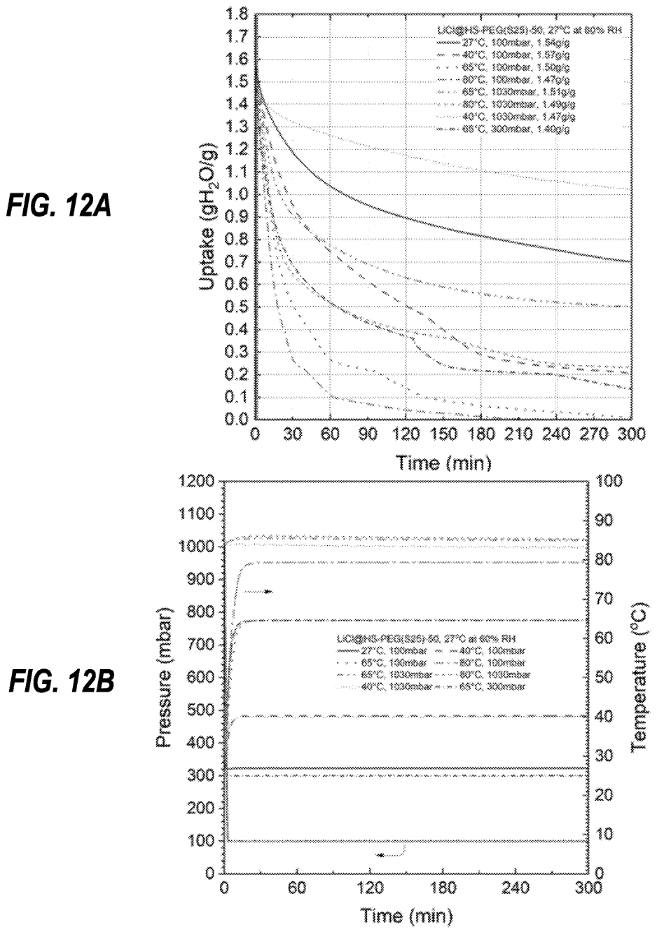

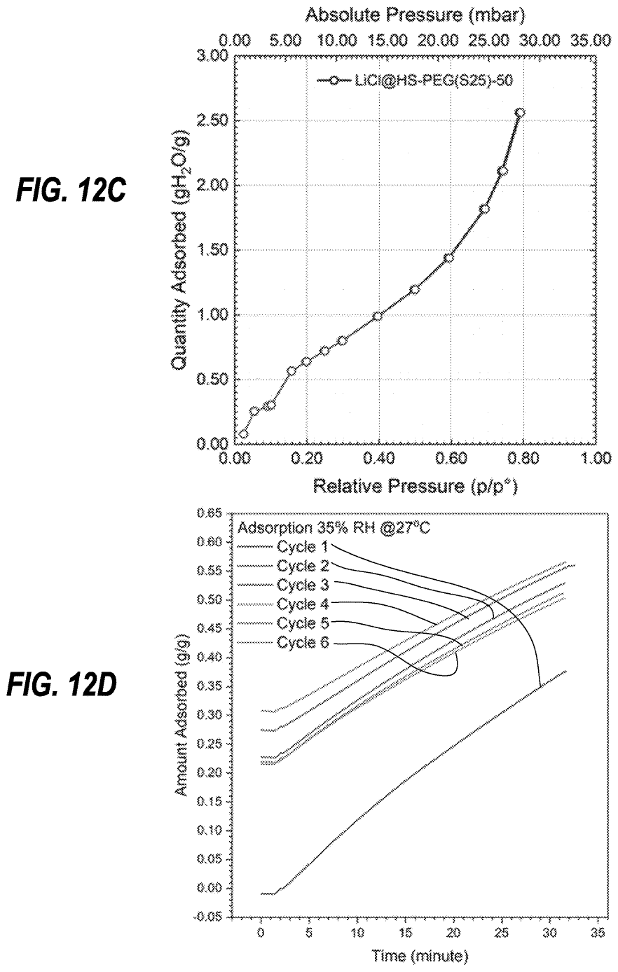

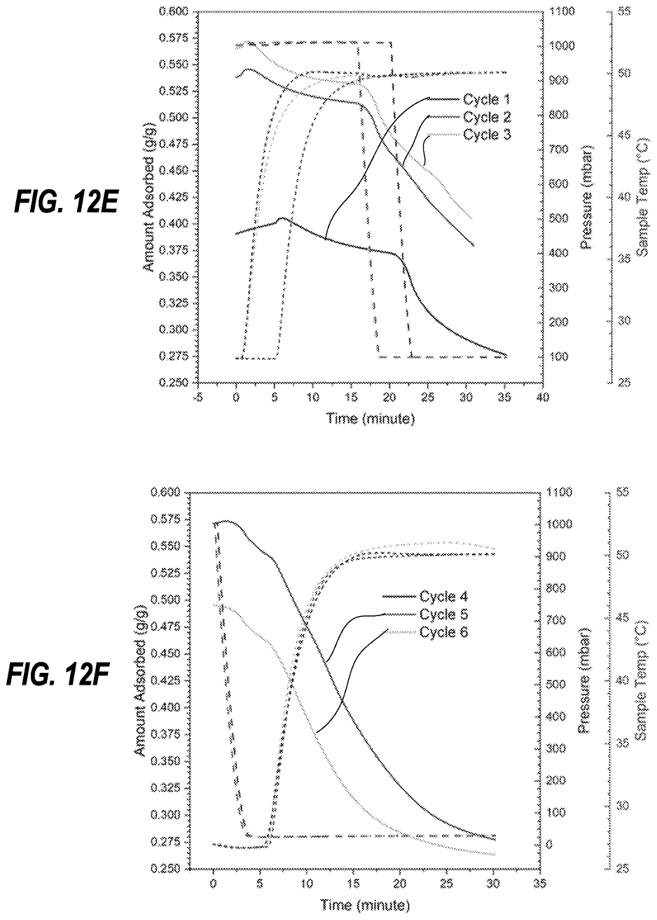

Referring to FIGS. 12A-12B, desorption profiles of water from a LiCl@HS-PEG(S25)-50 composite sorbent after saturation at 27 °C and 60% relative humidity under various temperature and vacuum conditions are depicted. FIG. 12A displays water uptake in grams of water per gram of sorbent on the vertical axis versus time in minutes on the horizontal axis. Multiple curves represent different desorption conditions including 27 °C at 100 mbar, 40 °C at 100 mbar, 65 °C at 100 mbar, 80 °C at 100 mbar, 65 °C at 1030 mbar, 80 °C at 1030 mbar, 40 °C at 1030 mbar, and 65 °C at 300 mbar. The legend indicates the final water uptake values for each condition, ranging from 1.40 g/g to 1.57 g/g.

As shown in FIG. 12A, the desorption of water from the composite sorbent can be performed under vacuum conditions ranging from 10 mbar to 1000 mbar in combination with heating temperatures from 27 °C to 150 °C, enabling pressure-swing and temperature-swing regeneration cycles. The curves show decreasing water uptake over time, with the rate and extent of desorption varying based on temperature and pressure conditions. Lower pressures and higher temperatures can result in faster and more complete water removal from the sorbent. For a fixed temperature, the amount desorbed can increase with decreasing pressure from 1000 mbar (ambient) to 300 mbar to 100 mbar to 10 mbar. This trend can be observed for all investigated temperatures.

With continued reference to FIG. 12B, the corresponding pressure in millibar on the left vertical axis and temperature in degrees Celsius on the right vertical axis are plotted against time in minutes on the horizontal axis. The pressure and temperature profiles show the experimental conditions applied during each desorption experiment, with pressure values ranging from approximately 100 mbar to 1030 mbar and temperatures ranging from 27 °C to approximately 90 °C. The profiles demonstrate the stepwise changes in pressure and temperature used to regenerate the sorbent under different operating conditions. In all cases, most water can be recovered within the first 30 minutes of the desorption regardless of pressure and for the sample saturated previously at 60% relative humidity.

The use of vacuum in tandem with heating can be an alternative to lower the regeneration temperature for reducing the cycle times when total cycle number per day is a priority. The amounts of water recovered can indicate that fast pressure swing cycles with mild temperatures can be used to maximize the number of cycles per day in water harvesting devices. The amount of water recovered can be determined prior to executing a pressure swing program, thus determining the working capacity of the sorbent and the device. Longer cycles at higher temperatures can lead to full water recovery but can decrease the number of cycles per day, whereas faster cycles can lead to a greater number of cumulative cycles per day.

Referring to FIGS. 12C-12D, a water vapor adsorption isotherm and adsorption cycling performance data for the LiCl@HS-PEG(S25)-50 composite sorbent material are depicted. FIG. 12C shows a water vapor adsorption isotherm plotting quantity adsorbed in grams of water per gram of sorbent on the vertical axis against relative pressure on the horizontal axis, with a corresponding secondary horizontal axis showing absolute pressure in millibar. The isotherm displays a characteristic Type II adsorption behavior, with the quantity adsorbed increasing from approximately 0.25 g H₂O/g at low relative pressures to approximately 2.5 g H₂O/g at a relative pressure of approximately 0.80, corresponding to an absolute pressure of approximately 30 mbar.

As shown in FIG. 12D, adsorption cycling performance at 35% relative humidity and 27 °C is presented, plotting amount adsorbed in grams per gram on the vertical axis against time in minutes on the horizontal axis. Six consecutive adsorption cycles are displayed, with each cycle showing water uptake over approximately 30 minutes. The cycles demonstrate consistent adsorption behavior, with the amount adsorbed reaching values between approximately 0.35 g/g and 0.55 g/g across the different cycles, indicating stable cycling performance and reproducibility of the sorbent material under the specified conditions. The total adsorption capacity of the composite sorbents can be maintained after every cycle and regeneration conditions investigated.

Referring to FIGS. 12E-12F, adsorption and desorption cycling data for composite sorbent materials are depicted. FIG. 12E shows three cycles labeled Cycle 1, Cycle 2, and Cycle 3, displaying the adsorption profiles as solid lines and the corresponding pressure and temperature profiles as dashed and dotted lines respectively. The left vertical axis represents amount adsorbed in grams per gram ranging from 0.250 to 0.600, the right vertical axis represents pressure in millibar ranging from 0 to 1100 and sample temperature in degrees Celsius ranging from 25 to 55, and the horizontal axis represents time in minutes.

As shown in FIG. 12E, the adsorption curves demonstrate water uptake behavior over approximately 40 minutes, with the amount adsorbed increasing from initial values around 0.275 to 0.400 grams per gram up to values between 0.525 and 0.575 grams per gram. The pressure profiles show a decrease from approximately 1000 millibar to around 100 millibar during the desorption phase, while the temperature profiles indicate heating from approximately 27 degrees Celsius to around 50 degrees Celsius. The materials can be activated at 150 °C under vacuum at 10 mbar pressure, exposed to 35% relative humidity with nitrogen as carrier gas for 30 minutes, and the desorption step can be performed by heating the samples to 50 °C for a total of 15 minutes and then applying vacuum for an additional 15 minutes at that temperature.

With continued reference to FIG. 12F, three additional cycles labeled Cycle 4, Cycle 5, and Cycle 6 are displayed with similar formatting, demonstrating continued cycling performance over approximately 35 minutes. The adsorption curves in FIG. 12F show comparable behavior to FIG. 12E, with the amount adsorbed reaching values between 0.550 and 0.575 grams per gram. The pressure profiles in FIG. 12F show a decrease from approximately 900 millibar to near 0 millibar, and the temperature profiles indicate similar heating patterns. Vertical shifts in the uptake or desorption curves can result from using the same dry weight for normalizing all cycles, as after each cycle, the starting weight can increase slightly when not all water is removed during short cycles.

The data across FIGS. 12E and 12F demonstrate the reproducibility and stability of the sorbent material through multiple adsorption-desorption cycles under controlled temperature and pressure conditions. The working capacity of the sorbent can be fully recovered after each cycle. The working capacity can increase by increasing the relative humidity in the feed. The cyclic performance of the composite sorbent materials confirms the cyclability of the developed sorbents, the modular working capacity, and the stability to conditions of high temperature and high vacuum. For the same cycle, the working capacity can be dictated by the selected sorbent.

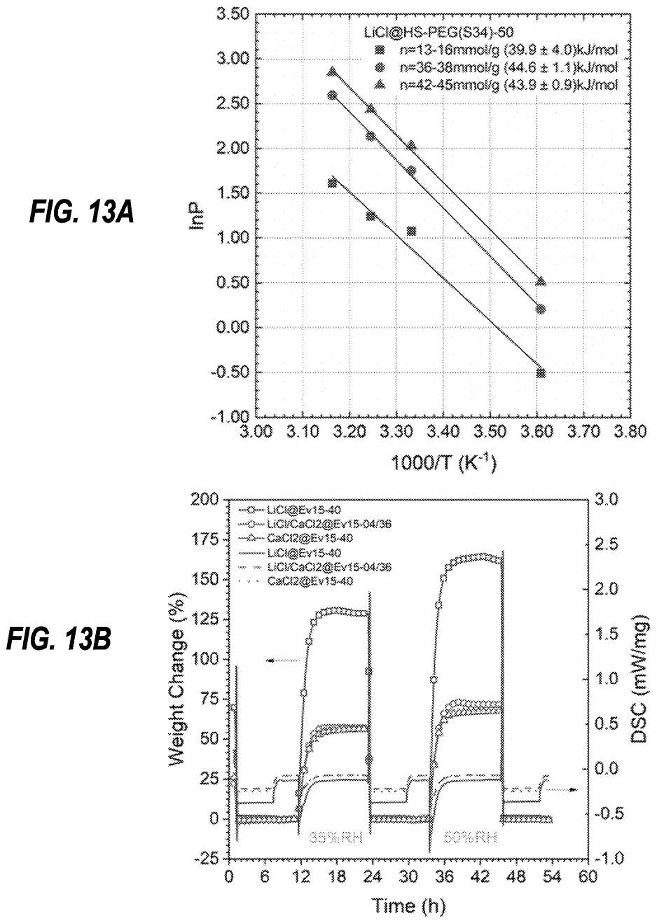

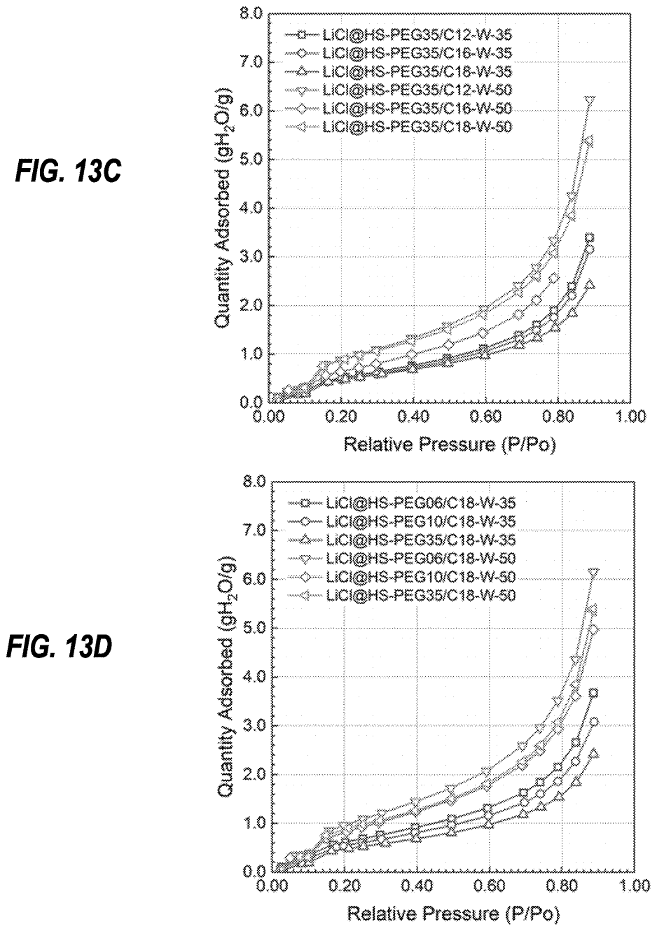

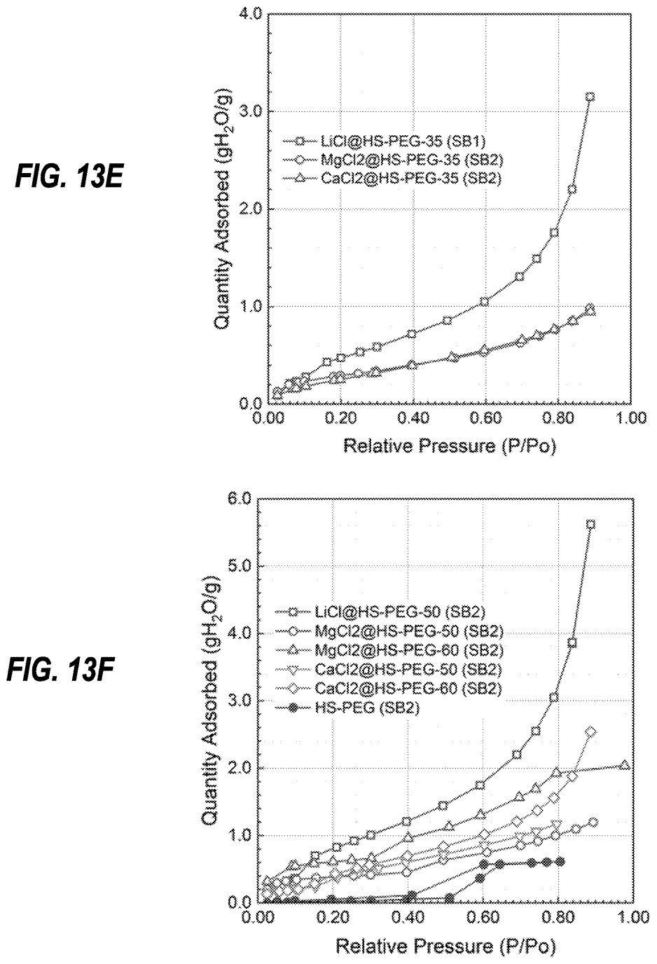

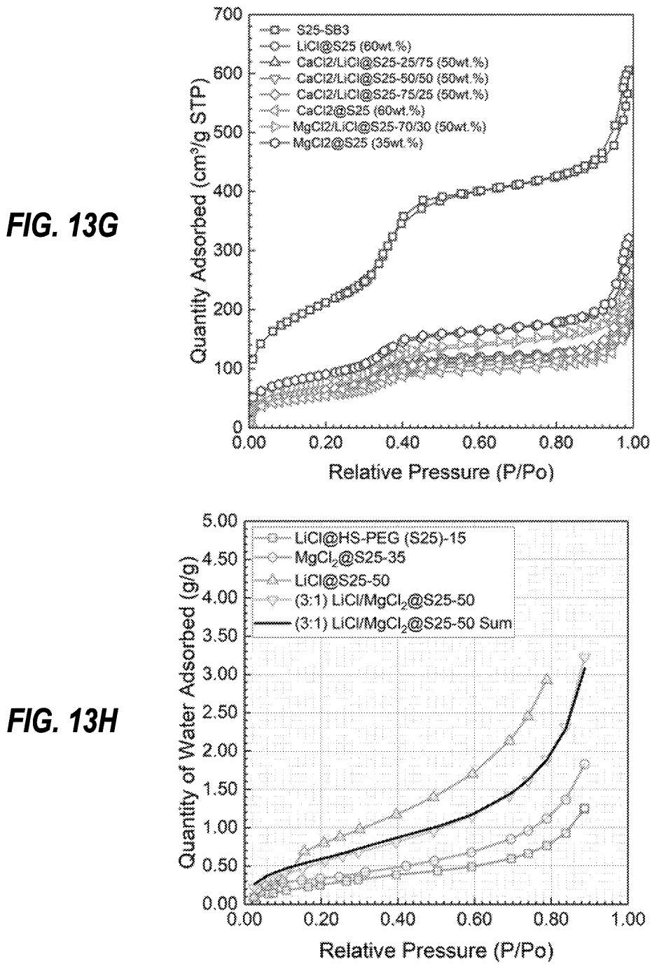

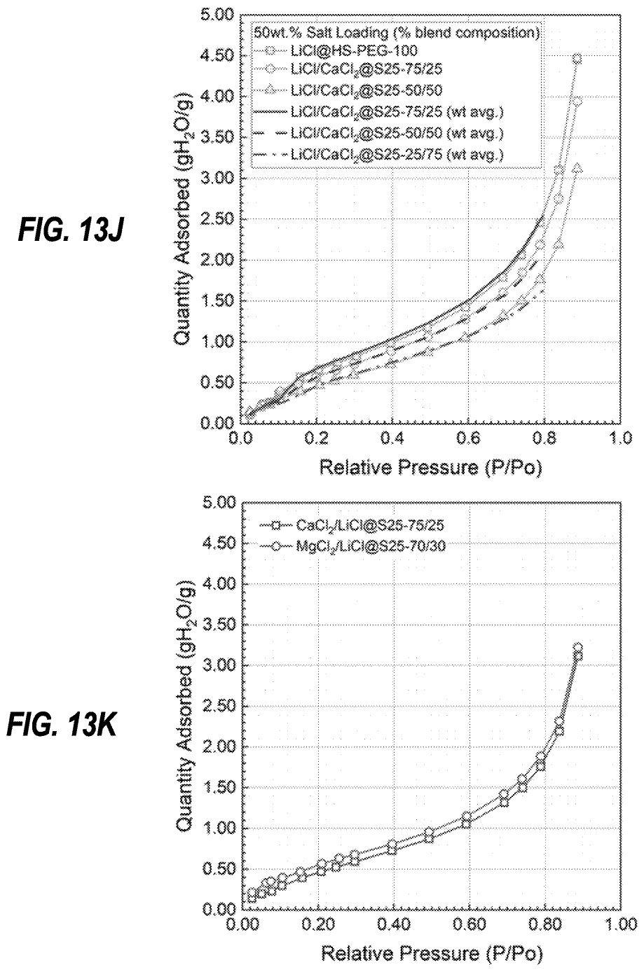

Referring to FIGS. 13A-13B, thermodynamic data for composite sorbent materials including isosteric heat of adsorption and differential scanning calorimetry measurements are depicted. FIG. 13A shows a graph presenting the relationship between the natural logarithm of pressure (lnP) on the vertical axis and the inverse of temperature multiplied by 1000 (1000/T in K⁻¹) on the horizontal axis for a LiCl@HS-PEG(S34)-50 composite sorbent material. The graph displays three distinct data series represented by different symbols corresponding to different water uptake ranges.

As shown in FIG. 13A, squares represent water uptake in the range of n=13-16 mmol/g with an associated heat of adsorption of 39.9±4.0 kJ/mol, circles represent water uptake in the range of n=36-38 mmol/g with a heat of adsorption of 44.6±1.1 kJ/mol, and triangles represent water uptake in the range of n=42-45 mmol/g with a heat of adsorption of 43.9±0.9 kJ/mol. Each data series follows a linear trend with fitted lines extending across the temperature range from approximately 3.00 to 3.70 K⁻¹ on the horizontal axis, corresponding to the Clausius-Clapeyron relationship used for calculating isosteric heats of adsorption. The lnP values range from approximately −1.00 to 3.50 on the vertical axis, with the data points for each uptake range showing decreasing lnP values as 1000/T increases.

The composite sorbent can exhibit an isosteric heat of adsorption for water in the range of 45 kJ/mol to 50 kJ/mol for lithium chloride-based composites. The isosteric heats of adsorption presented in FIG. 13A can be verified by water adsorption isotherms measured at temperatures of 277 K, 300 K, 308 K, and 316 K using the linear form of the Clausius-Clapeyron equation for selected data points. Each data point can correspond to fixed amounts of water adsorbed from each isotherm measured at the different temperatures.

With continued reference to FIG. 13B, a graph showing weight change percentage on the left vertical axis and differential scanning calorimetry (DSC) signal in mW/mg on the right vertical axis as functions of time in hours on the horizontal axis is depicted. The graph displays data for three different salt-silica composite sorbents: LiCl@Ev15-40 represented by open squares and solid lines, LiCl/CaCl₂@Ev15-04/36 represented by open circles and dashed lines, and CaCl₂@Ev15-40 represented by open triangles and dotted lines.

As shown in FIG. 13B, the weight change data shows cyclic adsorption-desorption behavior over a 60-hour period, with the materials exposed to 35% relative humidity and 50% relative humidity conditions as indicated on the graph. The LiCl@Ev15-40 composite exhibits the highest weight change reaching approximately 125-150%, while the CaCl₂@Ev15-40 shows lower weight changes of approximately 50-75%. The DSC curves corresponding to each material show thermal responses during the adsorption and desorption cycles, with values ranging from approximately −0.5 to 3.0 mW/mg.

The isosteric heats of adsorption calculated from the Clausius-Clapeyron analysis in FIG. 13A can match the enthalpy of adsorption measured by water vapor adsorption using the thermogravimetric-differential scanning calorimetry (TG-DSC) method shown in FIG. 13B. The thermodynamics of sorption can be dependent on the salt used in the composite sorbent. The desorption cycles can require only the amount of heat equivalent to the heat of vaporization of water of 40.65 kJ/mol, provided that the desorption step ends at a stage where the lithium chloride is not fully dehydrated. For full salt dehydration, the energy required can be the isosteric heat of adsorption.

For other salts, such as calcium chloride, comparable heats of adsorption can be observed, but the composites can have higher gravimetric capacity in terms of heat storage. Some salts can have endothermic heat of adsorption such as potassium chloride. Composites containing potassium chloride and pure potassium chloride salt can uptake most water at high relative humidity, and the endothermic process can be of interest for cooling in high humidity regions. Blending salts can lead to an average of the heats of adsorption for each salt in the blend. Thus, capacity and energy requirements for conducting sorption cycles can be modulated for different applications.

The composite sorbent can be used in thermal energy storage (TES) systems wherein the heat of adsorption-desorption processes between vapors and salts is utilized for heating and cooling applications. During adsorption, the composite sorbents can release heat as the hygroscopic salts become saturated with water vapor. During desorption, heat can be supplied to regenerate the sorbents, and the process can absorb heat and cool flowing air. The heat released during adsorption and absorbed during desorption can be quantified using the TG-DSC measurements shown in FIG. 13B, enabling design of thermal energy storage systems with predictable energy densities based on the salt composition and loading in the composite sorbent.

The composite sorbent can be used for dehumidification of air in technology industries to reduce energy input required for air conditioning of humid air. Humid air can require higher energy input for cooling compared to dry air. By removing water from air using the composite sorbent materials, the energy requirements for air conditioning can be reduced. The high water uptake capacity and favorable thermodynamics of the composite sorbents can enable efficient dehumidification across a range of relative humidity conditions encountered in technology industry applications.

Referring to FIGS. 13C-13D, water vapor adsorption isotherms at 300 K for LiCl-loaded hierarchical silica composite sorbents are depicted, showing the quantity of water adsorbed in grams of water per gram of sorbent as a function of relative pressure. FIG. 13C presents isotherms for composites prepared using polyethylene glycol with a molecular weight of 35,000 g/mol combined with different alkyl chain length surfactants including C12, C16, and C18, at salt loadings of 35 weight percent and 50 weight percent. The samples are designated as LiCl@HS-PEG35/C12-W-35, LiCl@HS-PEG35/C16-W-35, LiCl@HS-PEG35/C18-W-35, LiCl@HS-PEG35/C12-W-50, LiCl@HS-PEG35/C16-W-50, and LiCl@HS-PEG35/C18-W-50.

As shown in FIG. 13C, the water adsorption isotherms display Type II adsorption behavior characteristic of hygroscopic salt-loaded composites, with water uptake increasing gradually at low relative pressures and more steeply at higher relative pressures approaching saturation. The isotherms demonstrate that water adsorption capacity can scale with salt loading, with 50 weight percent loaded samples exhibiting higher uptakes than 35 weight percent loaded samples across the entire relative pressure range. The data in FIG. 13C shows that the mesopore size controlled by surfactant chain length does not substantially affect the water uptake when the polyethylene glycol molecular weight is held constant. Composite sorbents prepared using C12, C16, and C18 surfactants at the same salt loading exhibit comparable water uptake values, indicating that the mesopore width in the range of approximately 2.5 nm to 4.5 nm does not substantially influence the water adsorption capacity of the composite sorbent when the hygroscopic salt loading is the same.

With continued reference to FIG. 13D, isotherms for composites prepared using C18 surfactant combined with different molecular weight polyethylene glycol polymers including PEG06, PEG10, and PEG35, at salt loadings of 35 weight percent and 50 weight percent are presented. The samples are designated as LiCl@HS-PEG06/C18-W-35, LiCl@HS-PEG10/C18-W-35, LiCl@HS-PEG35/C18-W-35, LiCl@HS-PEG06/C18-W-50, LiCl@HS-PEG10/C18-W-50, and LiCl@HS-PEG35/C18-W-50.

The data in FIG. 13D demonstrates that the macropore size controlled by polyethylene glycol molecular weight similarly does not substantially affect water uptake when the surfactant chain length is held constant. Composite sorbents prepared using PEG06, PEG10, and PEG35 at the same salt loading exhibit comparable water uptake values, indicating that the macropore diameter in the range of approximately 100 nm to 3000 nm does not substantially influence the water adsorption capacity of the composite sorbent when the hygroscopic salt loading is the same. The water adsorption isotherms in FIG. 13D confirm that the salt loading can be the primary determinant of water adsorption capacity in the hierarchical silica composite sorbents, while the mesopore size and macropore size can be independently tuned to optimize other properties such as vapor diffusion kinetics and mechanical stability without substantially affecting the equilibrium water uptake capacity.

Referring to FIGS. 13E-13F, water adsorption isotherms at 300 K for composite sorbents prepared with different hygroscopic salts at various loadings are depicted. FIG. 13E presents isotherms for composites prepared with 35 weight percent salt loading, while FIG. 13F presents isotherms for composites prepared with 50 and 60 weight percent salt loadings. Both graphs plot quantity adsorbed in grams of water per gram of sorbent on the vertical axis against relative pressure expressed as P/Po on the horizontal axis, with the horizontal axis ranging from 0.00 to 1.00.

As shown in FIG. 13E, three composite materials are compared: LiCl@HS-PEG-35 prepared using small batch 1, MgCl₂@HS-PEG-35 prepared using small batch 2, and CaCl₂@HS-PEG-35 prepared using small batch 2. The data points are represented by open squares, open circles, and open triangles, respectively. The LiCl composite exhibits the highest water uptake, reaching approximately 3.2 grams of water per gram of sorbent at relative pressures approaching 1.0. The MgCl₂ and CaCl₂ composites show lower uptakes of approximately 1.0 gram of water per gram of sorbent at the same conditions. The difference in water uptake capacity between the LiCl composite and the MgCl₂ and CaCl₂ composites at the same 35 weight percent loading can be attributed to the lower molecular weight of lithium chloride compared to magnesium chloride and calcium chloride.

With continued reference to FIG. 13F, six materials are compared: LiCl@HS-PEG-50 prepared using small batch 2, MgCl₂@HS-PEG-50 prepared using small batch 2, MgCl₂@HS-PEG-60 prepared using small batch 2, CaCl₂@HS-PEG-50 prepared using small batch 2, CaCl₂@HS-PEG-60 prepared using small batch 2, and the bare HS-PEG support prepared using small batch 2. The data points are represented by open squares, open circles, open triangles, open inverted triangles, open diamonds, and filled circles, respectively.

The LiCl composite at 50 weight percent loading demonstrates the highest water uptake, reaching approximately 5.5 grams of water per gram of sorbent at high relative pressures. The CaCl₂@HS-PEG-60 composite shows the second highest uptake at approximately 2.7 grams of water per gram of sorbent, followed by MgCl₂@HS-PEG-60 at approximately 2.0 grams of water per gram of sorbent. The bare HS-PEG support exhibits the lowest water uptake, remaining below approximately 0.7 grams of water per gram of sorbent across all relative pressures measured.

The water uptake capacity of the composite sorbents can be modulated by the salt content in the composites. The maximum salt loading can be regulated by the mesopore width, mesopore volume, and by the density of the salt in its hydrated state. The total gravimetric capacity can decrease for salts having higher molecular weight than lithium chloride. The uptakes can be similarly modulated by the salt content in each composite. When the water adsorption isotherms are normalized as moles of water per mole of salt, the isotherms for composites containing different salts can coincide with those containing lithium chloride, indicating that the molar water uptake capacity per mole of salt can be comparable across different salt types while the gravimetric capacity can differ due to the molecular weight differences between the salts.

As further shown in FIGS. 13E and 13F, the water adsorption isotherms for all salt-loaded composites display Type II adsorption behavior, with water uptake increasing gradually at low relative pressures and more steeply at higher relative pressures. The bare HS-PEG support exhibits substantially lower water uptake compared to all salt-loaded composites, demonstrating that the hygroscopic salt can be responsible for the enhanced water adsorption capacity of the composite sorbents. The lithium chloride composites can achieve the highest gravimetric water adsorption capacity among the salts investigated due to the combination of the low molecular weight of lithium chloride and the high stoichiometry of water molecules that can be coordinated to the lithium chloride in its hydrated forms.

Referring to FIGS. 13G-13H, nitrogen adsorption isotherms and water adsorption isotherms for various salt-loaded silica composite sorbents including salt blends are depicted. FIG. 13G shows a graph with relative pressure (P/Po) on the horizontal axis ranging from 0.00 to 1.00 and quantity adsorbed in cubic centimeters per gram at standard temperature and pressure on the vertical axis ranging from 0 to 700. Multiple data series are plotted representing different composite materials including S25-SB3, LiCl@S25 at 60 weight percent, CaCl₂/LiCl@S25-25/75 at 50 weight percent, CaCl₂/LiCl@S25-50/50 at 50 weight percent, CaCl₂/LiCl@S25-75/25 at 50 weight percent, CaCl₂@S25 at 60 weight percent, MgCl₂/LiCl@S25-70/30 at 50 weight percent, and MgCl₂@S25 at 35 weight percent.

As shown in FIG. 13G, the nitrogen adsorption isotherms demonstrate Type IV behavior with capillary condensation steps occurring at low relative pressures, indicating the presence of uniform mesopores in the support materials. The varying heights of the condensation steps reflect differences in total pore volume resulting from different salt loadings and salt types. The hygroscopic salt can comprise a blend of two or more salts. The pore filling by salt blends can follow the same mechanism as for individual salts, as evidenced by the nitrogen isotherms in FIG. 13G. The composite sorbents containing salt blends such as CaCl₂/LiCl and MgCl₂/LiCl exhibit capillary condensation steps at similar relative pressures as the composites containing individual salts, indicating that the mesopore structure of the support can be preserved regardless of whether a single salt or a salt blend is used for impregnation.

With continued reference to FIG. 13H, water adsorption isotherms at 300 K for composite sorbents containing individual salts and salt blends are presented. The graph shows relative pressure (P/Po) on the horizontal axis ranging from 0.00 to 1.00 and quantity of water adsorbed in grams per gram on the vertical axis ranging from 0.00 to 5.00. Data series are plotted for LiCl@HS-PEG (S25)-15, MgCl₂@S25-35, LiCl@S25-50, (3:1) LiCl/MgCl₂@S25-50, and a calculated sum line for (3:1) LiCl/MgCl₂@S25-50.

As shown in FIG. 13H, the water adsorption capacity of the composite sorbent can be predictable based on a weighted average of water adsorption capacities of composite sorbents containing each salt individually. The calculated sum line for the (3:1) LiCl/MgCl₂@S25-50 blend closely corresponds to the measured water adsorption isotherm for the same blend composition, demonstrating that the uptakes of supported salt blends can be predicted using a weighted average of the uptakes of the sorbents having a single salt type. The total loading of salt blends in silica that is stable can match those found for lithium chloride on the same supports. For instance, if up to 50 wt % lithium chloride in HS-PEG is stable, the same can be valid for blends of lithium chloride with any other salt with a composition of 50 wt % of both salts combined in the final sorbent composites.

Referring to FIGS. 13J-13K, water adsorption isotherms at 300 K for composite sorbents containing salt blends supported on hierarchical porous silica are depicted. FIG. 13J displays quantity adsorbed in grams of water per gram of sorbent on the vertical axis versus relative pressure (P/Po) on the horizontal axis, ranging from 0.0 to 1.0. The graph presents data for materials with 50 weight percent salt loading at various blend compositions. The legend indicates six different samples: LiCl@HS-PEG-100 shown with square markers, LiCl/CaCl₂@S25-75/25 shown with circle markers, LiCl/CaCl₂@S25-50/50 shown with triangle markers, and three weighted average predictions for LiCl/CaCl₂@S25-75/25, LiCl/CaCl₂@S25-50/50, and LiCl/CaCl₂@S25-25/75 shown with solid, dashed, and dash-dot lines respectively.

As shown in FIG. 13J, the isotherms demonstrate that the water uptake of salt blend composites can fall between the uptakes of the individual salt components, and that the experimental data closely follows the weighted average predictions based on the blend ratios. Blending salts with lithium chloride, such as the hygroscopic salts sodium chloride, potassium chloride, magnesium chloride, and calcium chloride, can lead to composites with additive effects of water uptake. The uptake at any relative humidity can be between the uptakes of the composites having only one of those salts and the one with lithium chloride only. The water isotherms for salt blends can be predicted by the sum of the uptake of the individual components, enabling design of composite sorbents with tailored water adsorption properties based on the known behavior of the individual salt components.

With continued reference to FIG. 13K, water adsorption isotherms comparing two different salt blend systems are presented. The graph shows quantity adsorbed in grams of water per gram of sorbent on the vertical axis versus relative pressure (P/Po) on the horizontal axis, ranging from 0.00 to 1.00. Two salt blend systems are compared: CaCl₂/LiCl@S25-75/25 shown with square markers and MgCl₂/LiCl@S25-70/30 shown with circle markers.

As shown in FIG. 13K, the two isotherms exhibit similar water uptake behavior across the entire relative pressure range, demonstrating that salt blends with comparable molar compositions and similar individual component uptakes can yield similar overall water adsorption performance regardless of the specific salt combination used. Salt blends having similar molar compositions, loadings, and similar uptakes for the individual components can have similar water uptakes. The molar ratio of the salts can dictate the final uptake of the composite sorbent. The predictability of water adsorption capacity based on the weighted average of individual salt uptakes can enable rational design of composite sorbents for specific applications where particular water uptake profiles are desired across the relative humidity range of interest.

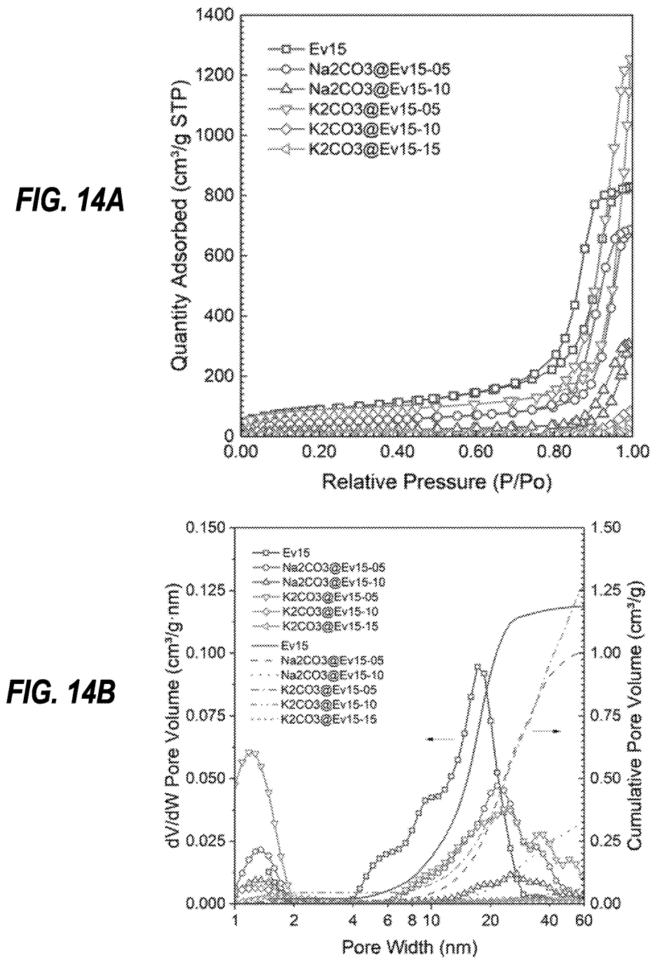

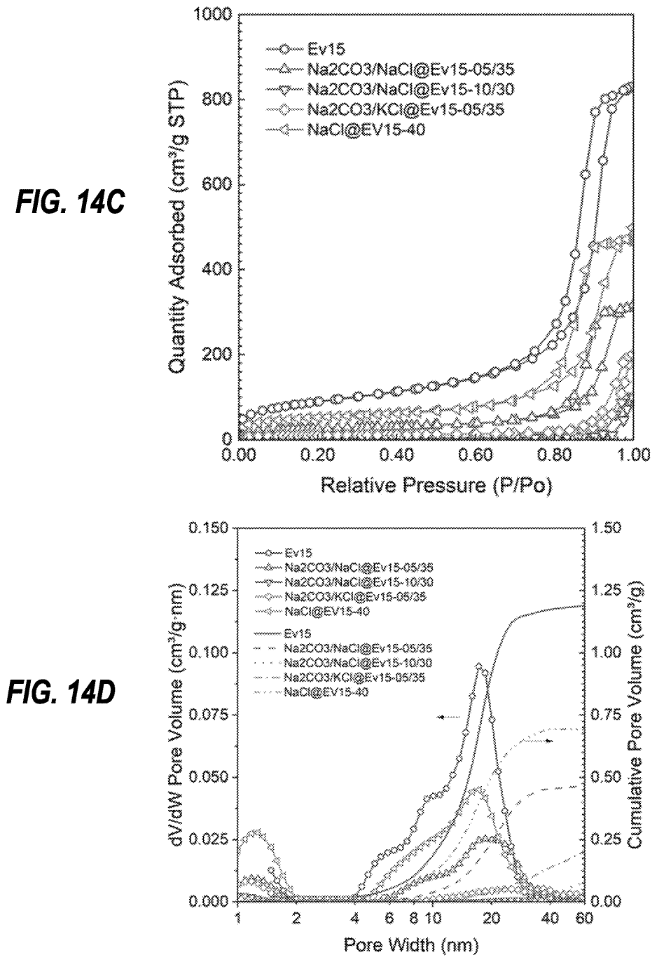

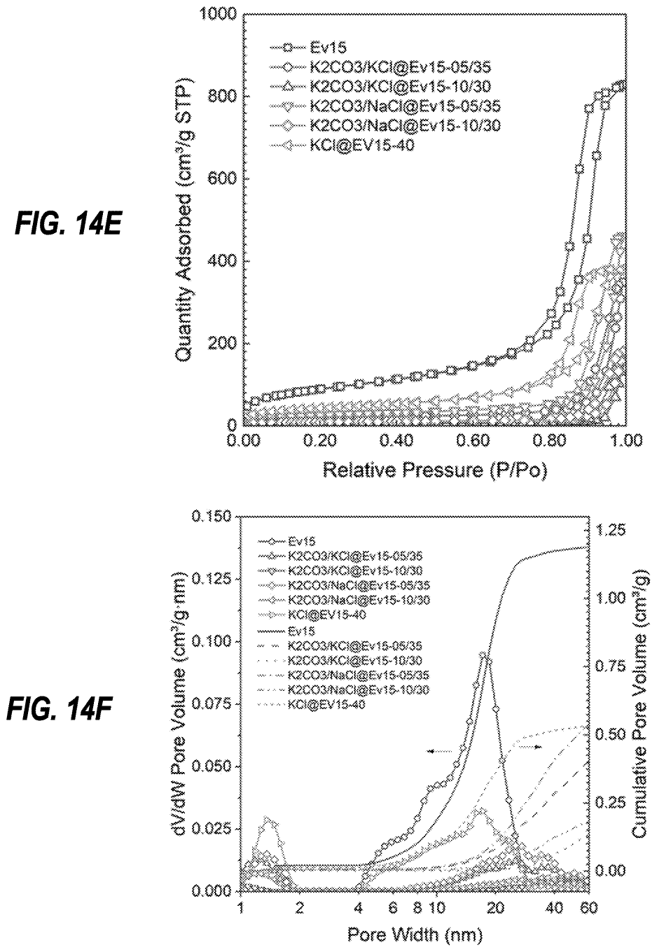

Referring to FIG. 14A, nitrogen adsorption-desorption isotherms at 77 K and corresponding pore size distribution curves for a silica support material and composite sorbents prepared with sodium carbonate and potassium carbonate salts at various loading levels are depicted. The upper panel shows quantity adsorbed in cubic centimeters per gram at standard temperature and pressure plotted against relative pressure from 0.00 to 1.00. Seven samples are represented, including an unloaded silica support designated Ev15, sodium carbonate loaded samples at 5 and 10 weight percent designated Na₂CO₃@Ev15-05 and Na₂CO₃@Ev15-10, and potassium carbonate loaded samples at 5, 10, and 15 weight percent designated K₂CO₃@Ev15-05, K₂CO₃@Ev15-10, and K₂CO₃@Ev15-15.

The hygroscopic salt can comprise a carbonate salt selected from sodium carbonate (Na₂CO₃) or potassium carbonate (K₂CO₃), which can react with water and CO₂ to form bicarbonates for CO₂ capture applications. As shown in FIG. 14A, the isotherms exhibit Type IV character with hysteresis loops at high relative pressures, indicating mesoporous structures. The unloaded Ev15 support shows the highest adsorption capacity, reaching approximately 1200 to 1300 cubic centimeters per gram at saturation, while the carbonate-loaded samples show progressively lower adsorption capacities with increasing salt loading.

With continued reference to FIG. 14A, the lower panel presents pore size distribution data with pore width in nanometers on a logarithmic horizontal axis ranging from 1 nm to 60 nm. The left vertical axis shows differential pore volume in cubic centimeters per gram per nanometer, while the right vertical axis shows cumulative pore volume in cubic centimeters per gram. The differential pore volume curves display peaks centered around 15 nm to 30 nm for the various samples, with the unloaded Ev15 support exhibiting the highest peak intensity near 0.050 to 0.060 cubic centimeters per gram per nanometer. The cumulative pore volume curves demonstrate that the unloaded support achieves the highest total pore volume of approximately 1.25 cubic centimeters per gram, while the carbonate-loaded samples show reduced cumulative pore volumes corresponding to partial pore filling by the deposited salts. The carbonate loading can be limited to approximately 5 wt % to retain accessible mesopores in the composite sorbent, as higher carbonate loadings can result in substantial reduction of the mesopore volume available for vapor diffusion and adsorption.

Referring to FIGS. 14C-14D, nitrogen adsorption isotherms at 77 K and corresponding pore size distribution curves for hierarchical silica materials loaded with blends of carbonate salts and chloride salts are depicted. The hygroscopic salt can comprise a blend of a carbonate salt and a chloride salt, such as Na₂CO₃/NaCl, Na₂CO₃/KCl, K₂CO₃/NaCl, or K₂CO₃/KCl, wherein the carbonate loading is limited to approximately 5 wt % to retain accessible mesopores. FIG. 14C shows quantity adsorbed in cubic centimeters per gram at standard temperature and pressure plotted against relative pressure from 0.00 to 1.00. Five different samples are represented: Ev15, Na₂CO₃/NaCl@Ev15-05/35, Na₂CO₃/NaCl@Ev15-10/30, Na₂CO₃/KCl@Ev15-05/35, and NaCl@EV15-40.

As shown in FIG. 14C, the isotherms display Type IV characteristics with capillary condensation steps occurring at relative pressures between approximately 0.60 and 0.90, indicating the presence of mesopores. The Ev15 sample exhibits the highest total adsorption capacity reaching approximately 850 cubic centimeters per gram at saturation, while the salt-loaded samples show progressively lower adsorption capacities. The composite sorbents containing carbonate/chloride blends with 5 wt % carbonate loading, such as Na₂CO₃/NaCl@Ev15-05/35 and Na₂CO₃/KCl@Ev15-05/35, retain accessible mesopore structure as evidenced by the well-defined capillary condensation steps in the isotherms.

With continued reference to FIG. 14D, the pore size distribution data presents differential pore volume in cubic centimeters per gram per nanometer on the left vertical axis and cumulative pore volume in cubic centimeters per gram on the right vertical axis, both plotted against pore width in nanometers on a logarithmic scale ranging from 1 nm to 60 nm. The pore size distribution curves show peaks centered between approximately 10 nm and 30 nm for the various samples. The cumulative pore volume curves demonstrate that the Ev15 sample possesses the highest total pore volume of approximately 1.25 cubic centimeters per gram, while the salt-loaded composites exhibit reduced pore volumes consistent with pore filling by the impregnated salts. The data illustrate that carbonate and chloride salt blends can be successfully loaded into the hierarchical silica support while retaining accessible mesopore structure when the carbonate loading is maintained at approximately 5 wt %.

Referring to FIGS. 14E-14F, nitrogen adsorption isotherms at 77 K and corresponding pore size distribution curves for a silica support material and various salt-impregnated composite sorbents containing potassium carbonate blended with chloride salts are depicted. FIG. 14E shows quantity adsorbed in cubic centimeters per gram at standard temperature and pressure plotted against relative pressure from 0.00 to 1.00. Multiple samples are represented including the bare silica support designated Ev15, potassium carbonate with potassium chloride composites at two different loading ratios designated K₂CO₃/KCl@Ev15-05/35 and K₂CO₃/KCl@Ev15-10/30, potassium carbonate with sodium chloride composites at two different loading ratios designated K₂CO₃/NaCl@Ev15-05/35 and K₂CO₃/NaCl@Ev15-10/30, and a potassium chloride composite designated KCl@EV15-40.

As shown in FIG. 14E, the bare silica support exhibits the highest adsorption capacity reaching approximately 850 cubic centimeters per gram at saturation, while the salt-loaded composites show progressively reduced adsorption capacities consistent with pore filling by the impregnated salts. The composite sorbents containing K₂CO₃/KCl and K₂CO₃/NaCl blends with 5 wt % carbonate loading exhibit well-defined capillary condensation steps, indicating retention of the mesopore structure. The composite sorbents with 10 wt % carbonate loading show further reduced adsorption capacities, demonstrating that higher carbonate loadings can result in greater pore filling and reduced accessible mesopore volume.

With continued reference to FIG. 14F, the pore size distribution data displays differential pore volume in cubic centimeters per gram per nanometer on the left vertical axis and cumulative pore volume in cubic centimeters per gram on the right vertical axis, both plotted against pore width in nanometers on a logarithmic scale ranging from 1 nm to 60 nm. The differential pore volume curves demonstrate that the bare silica support exhibits a prominent peak centered near 20 nm, while the salt-loaded composites show substantially reduced peak intensities indicating systematic filling of the mesopores upon salt impregnation. The cumulative pore volume curves confirm that the bare silica support possesses the highest total pore volume exceeding 1.0 cubic centimeters per gram, while the composite materials exhibit reduced cumulative pore volumes proportional to their salt loading levels.

The composite sorbent can be used for direct air capture (DAC) of CO₂ from streams containing approximately 400 ppm CO₂ when formulated with carbonate salts that react with water and CO₂ to form bicarbonates. The carbonate salts in the composite sorbent can react with water vapor and CO₂ according to the reaction between the carbonate and water and CO₂ to form bicarbonate species. The formation of bicarbonate species can enable capture and retention of CO₂ from dilute gas streams such as ambient air. The carbonate/chloride salt blends can provide composite sorbents that combine the CO₂ capture capability of the carbonate component with the water adsorption capability of the chloride component, enabling co-adsorption of water and CO₂ in single-bed systems or sequential adsorption in two-bed systems depending on the relative concentrations of water vapor and CO₂ in the inlet stream.

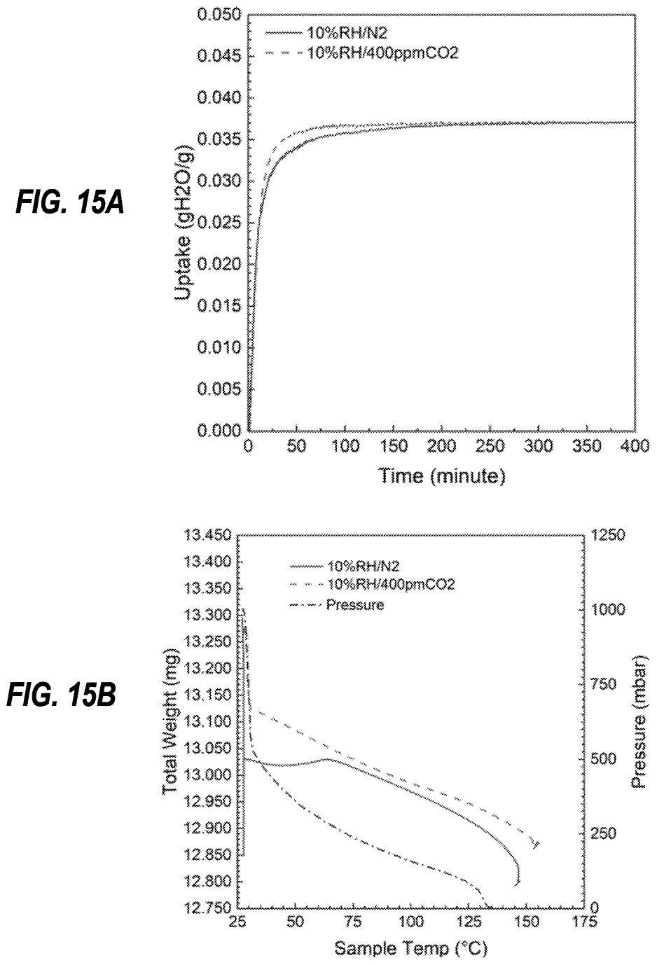

Referring to FIGS. 15A-15B, water adsorption and desorption behavior for a composite sorbent exposed to humid nitrogen versus humid air containing 400 ppm CO₂ is depicted. FIG. 15A shows water uptake as a function of time for a sorbent exposed to two different gas streams: one containing 10% relative humidity in nitrogen and another containing 10% relative humidity with 400 ppm carbon dioxide. The vertical axis represents uptake measured in grams of water per gram of sorbent, ranging from 0.000 to 0.050, while the horizontal axis represents time in minutes, ranging from 0 to 400.

As shown in FIG. 15A, both curves exhibit rapid initial uptake followed by gradual saturation, with the curves reaching similar equilibrium values near 0.037 grams of water per gram of sorbent. The comparable equilibrium water uptake values for the two gas streams indicate that the presence of 400 ppm CO₂ does not substantially affect the water adsorption capacity of the composite sorbent under the investigated conditions. The composite sorbent can adsorb water from humid gas streams regardless of whether CO₂ is present at ambient concentrations.

With continued reference to FIG. 15B, total weight and pressure as functions of sample temperature during a desorption process are presented. The left vertical axis shows total weight in milligrams, ranging from approximately 12.750 to 13.450, while the right vertical axis displays pressure in millibar, ranging from 0 to 1250. The horizontal axis represents sample temperature in degrees Celsius, ranging from 25 to 175. Two weight curves are shown corresponding to samples previously exposed to the two different gas streams, along with a pressure curve that decreases as temperature increases.

As shown in FIG. 15B, the sample exposed to the carbon dioxide-containing stream exhibits a slightly higher onset temperature for weight loss and retains more mass at elevated temperatures compared to the sample exposed to nitrogen alone. The higher onset temperature and greater mass retention can indicate the formation of bicarbonate species when carbon dioxide is present during adsorption. The carbonate salts in the composite sorbent can react with water vapor and CO₂ to form bicarbonate species, which can require higher temperatures for decomposition compared to hydrated salt species formed in the absence of CO₂. The formation of bicarbonate species can enable capture and retention of CO₂ from dilute gas streams such as ambient air containing approximately 400 ppm CO₂, demonstrating the applicability of the composite sorbent for direct air capture applications.

The composite sorbent can be used for ammonia adsorption and storage applications, wherein the hygroscopic salts form ammoniates and ammonia complexes for safe storage and transport of ammonia. The hygroscopic salt can comprise alkaline, alkaline earth, and transition metal salts including VF₂, CoF₃, or NiCl₂·6H₂O that form ammoniates and ammonia complexes for ammonia storage applications. The metal salts can coordinate ammonia molecules to form stable ammoniate complexes that can be stored and transported safely, with ammonia release occurring upon heating or pressure reduction. The hierarchical pore structure of the silica support can facilitate ammonia diffusion to the salt-containing mesopores while providing mechanical stability for the composite sorbent during ammonia adsorption-desorption cycling.

The composite sorbent can comprise ionic liquids (ILs) or deep eutectic solvents (DES) confined within the mesopores as alternatives to or in combination with hygroscopic salts for water and gas adsorption. Ionic liquids can comprise ionic compounds formed between an organic cation and an inorganic anion with low melting temperatures. Deep eutectic solvents can comprise ionic compounds formed between an organic cation and an inorganic anion in combination with an organic compound acting as a hydrogen bonding donor, where the combination exhibits a deep drop in melting temperature at the eutectic composition. The ionic liquids and deep eutectic solvents can exhibit different heats of adsorption and uptake capacities compared to hygroscopic salts, and can act similar to salts when confined to the porous silica matrix. The composite sorbent can comprise IL-salt blends, wherein an ionic liquid is blended with one or more hygroscopic salts, or DES-salt blends, wherein a deep eutectic solvent is blended with one or more hygroscopic salts. The ionic liquids, deep eutectic solvents, IL-salt blends, and DES-salt blends can be used to tailor the adsorption properties of the composite sorbent for specific applications.

The composite sorbent can be integrated with surfaces using a waterborne epoxide resin crosslinked with an amide compound to form sorbent-resin composites suitable for coating applications. The sorbent-resin composites can enable integration of the composite sorbent powders with different surfaces for use in atmospheric water generation devices, thermal energy storage systems, and gas separation applications. The waterborne epoxide resin can bind the solid sorbent powders while the amide compound can crosslink the resin to provide mechanical stability and adhesion to the substrate surface. The sorbent-resin composites can be applied as coatings to substrates of various geometries, enabling fabrication of sorbent beds and sorbent-coated heat exchangers for integration with water harvesting and thermal management devices.

The disclosed technology can be further understood according to the following clauses:

Clause 1: A hierarchical porous silica material, comprising: a silica framework defining a plurality of mesopores having a pore width in a range of 2 nm to 11 nm; and a plurality of macropores having a pore diameter in a range of 0.1 μm to 100 μm; wherein the mesopores exhibit a narrow pore size distribution with a full width at half maximum of less than 2 nm, and wherein the macropores are formed by aggregation of primary silica particles.

Clause 2: The hierarchical porous silica material of clause 1, wherein the mesopores have a pore width in a range of 2 nm to 6 nm.

Clause 3: The hierarchical porous silica material of clause 2, wherein the mesopores have a pore width in a range of 3 nm to 5 nm.

Clause 4: The hierarchical porous silica material of clause 1, wherein the macropores have a pore diameter in a range of 0.1 μm to 10 μm.

Clause 5: The hierarchical porous silica material of clause 1, wherein the silica framework has a BET surface area greater than 400 m²/g.

Clause 6: The hierarchical porous silica material of clause 5, wherein the silica framework has a BET surface area in a range of 600 m²/g to 900 m²/g.

Clause 7: The hierarchical porous silica material of clause 1, wherein the silica framework has a mesopore volume in a range of 0.3 cm³/g to 1.1 cm³/g.

Clause 8: The hierarchical porous silica material of clause 1, wherein the silica framework has a total pore volume including mesopores and macropores in a range of 4 cm³/g to 8 cm³/g.

Clause 9: The hierarchical porous silica material of clause 1, wherein the primary silica particles have a secondary aggregate particle size in a range of 10 μm to 35 μm.

Clause 10: A method for preparing a hierarchical porous silica material, comprising: dissolving a surfactant and a polymer in a solvent to form a solution, wherein the surfactant comprises an alkyltrimethylammonium bromide and the polymer comprises polyethylene glycol having a molecular weight of at least 10,000 g/mol; adding a silica precursor to the solution; adding a condensation catalyst to the solution to form a silica gel; subjecting the silica gel to hydrothermal treatment; and calcining the silica gel to remove the surfactant and the polymer, thereby producing a hierarchical porous silica material having mesopores templated by the surfactant and macropores templated by the polymer.

Clause 11: The method of clause 10, wherein the alkyltrimethylammonium bromide is selected from the group consisting of decyltrimethylammonium bromide, dodecyltrimethylammonium bromide, tetradecyltrimethylammonium bromide, cetyltrimethylammonium bromide, and trimethyloctadecylammonium bromide.

Clause 12: The method of clause 11, wherein the alkyltrimethylammonium bromide is cetyltrimethylammonium bromide.

Clause 13: The method of clause 10, wherein the polyethylene glycol has a molecular weight in a range of 10,000 g/mol to 35,000 g/mol.

Clause 14: The method of clause 10, wherein the condensation catalyst comprises ammonium hydroxide.

Clause 15: The method of clause 14, wherein the hydrothermal treatment is performed at a temperature in a range of 80 °C to 120 °C for a duration of 12 hours to 48 hours.

Clause 16: A composite sorbent, comprising: a hierarchical porous silica support comprising mesopores having a pore width in a range of 2 nm to 11 nm and macropores having a pore diameter greater than 50 nm; and a hygroscopic salt disposed within the mesopores of the hierarchical porous silica support, wherein the hygroscopic salt is present in an amount of 5 wt % to 60 wt % based on a total weight of the composite sorbent.

Clause 17: The composite sorbent of clause 16, wherein the hygroscopic salt comprises at least one salt selected from the group consisting of lithium chloride, lithium bromide, lithium fluoride, lithium nitrate, lithium acetate, sodium chloride, sodium fluoride, sodium carbonate, potassium chloride, potassium fluoride, potassium carbonate, magnesium chloride, magnesium sulfate, calcium chloride, calcium fluoride, calcium nitrate, calcium acetate, strontium chloride, strontium bromide, vanadium difluoride, cobalt trifluoride, nickel chloride hexahydrate, ammonium chloride, ammonium carbonate, and ammonium nitrate.

Clause 18: The composite sorbent of clause 17, wherein the hygroscopic salt comprises lithium chloride.

Clause 19: The composite sorbent of clause 18, wherein the lithium chloride is present in an amount of 35 wt % to 60 wt % based on the total weight of the composite sorbent.

Clause 20: The composite sorbent of clause 16, wherein the hygroscopic salt comprises a blend of two or more salts, and wherein a water adsorption capacity of the composite sorbent is predictable based on a weighted average of water adsorption capacities of composite sorbents containing each salt individually.

A number of implementations have been described. Nevertheless, it will be understood that various modifications may be made without departing from the spirit and scope of the disclosure. Accordingly, other implementations are within the scope of the following claims.

1. A hierarchical porous silica material, comprising:
a silica framework defining a plurality of mesopores having a pore width in a range of 2 nm to 11 nm; and
a plurality of macropores having a pore diameter in a range of 0.1 μm to 100 μm;
wherein the mesopores exhibit a narrow pore size distribution with a full width at half maximum of less than 2 nm, and wherein the macropores are formed by aggregation of primary silica particles.

2. The hierarchical porous silica material of claim 1, wherein the mesopores have a pore width in a range of 2 nm to 6 nm.

3. The hierarchical porous silica material of claim 2, wherein the mesopores have a pore width in a range of 3 nm to 5 nm.

4. The hierarchical porous silica material of claim 1, wherein the macropores have a pore diameter in a range of 0.1 μm to 10 μm.

5. The hierarchical porous silica material of claim 1, wherein the silica framework has a BET surface area greater than 400 m²/g.

6. The hierarchical porous silica material of claim 5, wherein the silica framework has a BET surface area in a range of 600 m²/g to 900 m²/g.

7. The hierarchical porous silica material of claim 1, wherein the silica framework has a mesopore volume in a range of 0.3 cm³/g to 1.1 cm³/g.

8. The hierarchical porous silica material of claim 1, wherein the silica framework has a total pore volume including mesopores and macropores in a range of 4 cm³/g to 8 cm³/g.

9. The hierarchical porous silica material of claim 1, wherein the primary silica particles have a secondary aggregate particle size in a range of 10 μm to 35 μm.

10. A method for preparing a hierarchical porous silica material, comprising:
dissolving a surfactant and a polymer in a solvent to form a solution, wherein the surfactant comprises an alkyltrimethylammonium bromide and the polymer comprises polyethylene glycol having a molecular weight of at least 10,000 g/mol;
adding a silica precursor to the solution;
adding a condensation catalyst to the solution to form a silica gel;
subjecting the silica gel to hydrothermal treatment; and
calcining the silica gel to remove the surfactant and the polymer, thereby producing a hierarchical porous silica material having mesopores templated by the surfactant and macropores templated by the polymer.

11. The method of claim 10, wherein the alkyltrimethylammonium bromide is selected from the group consisting of decyltrimethylammonium bromide, dodecyltrimethylammonium bromide, tetradecyltrimethylammonium bromide, cetyltrimethylammonium bromide, and trimethyloctadecylammonium bromide.

12. The method of claim 11, wherein the alkyltrimethylammonium bromide is cetyltrimethylammonium bromide.

13. The method of claim 10, wherein the polyethylene glycol has a molecular weight in a range of 10,000 g/mol to 35,000 g/mol.

14. The method of claim 10, wherein the condensation catalyst comprises ammonium hydroxide.

15. The method of claim 14, wherein the hydrothermal treatment is performed at a temperature in a range of 80 °C to 120 °C for a duration of 12 hours to 48 hours.

16. A composite sorbent, comprising:
a hierarchical porous silica support comprising mesopores having a pore width in a range of 2 nm to 11 nm and macropores having a pore diameter greater than 50 nm; and
a hygroscopic salt disposed within the mesopores of the hierarchical porous silica support, wherein the hygroscopic salt is present in an amount of 5 wt % to 60 wt % based on a total weight of the composite sorbent.

17. The composite sorbent of claim 16, wherein the hygroscopic salt comprises at least one salt selected from the group consisting of lithium chloride, lithium bromide, lithium fluoride, lithium nitrate, lithium acetate, sodium chloride, sodium fluoride, sodium carbonate, potassium chloride, potassium fluoride, potassium carbonate, magnesium chloride, magnesium sulfate, calcium chloride, calcium fluoride, calcium nitrate, calcium acetate, strontium chloride, strontium bromide, vanadium difluoride, cobalt trifluoride, nickel chloride hexahydrate, ammonium chloride, ammonium carbonate, and ammonium nitrate.

18. The composite sorbent of claim 17, wherein the hygroscopic salt comprises lithium chloride.

19. The composite sorbent of claim 18, wherein the lithium chloride is present in an amount of 35 wt % to 60 wt % based on the total weight of the composite sorbent.

20. The composite sorbent of claim 16, wherein the hygroscopic salt comprises a blend of two or more salts, and wherein a water adsorption capacity of the composite sorbent is predictable based on a weighted average of water adsorption capacities of composite sorbents containing each salt individually.
